(19) United States
(12) Patent Application Publication
(10) Pub. No.: US 2015/0255044 A1
(43) Pub. Date: Sep. 10, 2015

(54) CONTOUR LINE WIDTH SETTING DEVICE, CONTOUR GRADATION NUMBER SETTING DEVICE, CONTOUR LINE WIDTH SETTING METHOD, AND CONTOUR GRADATION NUMBER SETTING METHOD

(71) Applicant: SHARP KABUSHIKI KAISHA, Osaka-shi, Osaka (JP)

(72) Inventors: Naomi Hirasawa, Osaka-shi (JP); Toshiyuki Tanaka, Osaka-shi (JP)

(73) Assignee: SHARP KABUSHIKI KAISHA, Osaka-shi, Osaka (JP)

(21) Appl. No.: 14/431,196

(22) PCT Filed: Sep. 26, 2013
(86) PCT No.: PCT/JP2013/076101

§ 371 Date: Mar. 25, 2015

(30) Foreign Application Priority Data
Sep. 27, 2012 (JP) 2012-215205
Sep. 27, 2012 (JP) 2012-215206
Sep. 19, 2013 (JP) 2013-194690

(51) Int. Cl. G09G 5/26; H04N 21/435; H04N 21/431; G06T 3/40; H04N 5/445

(52) U.S. Cl. CPC G09G 5/26; G06T 3/4092; H04N 5/44504; H04N 21/4312; H04N 21/4356; G09G 2320/08; G09G 2340/04

(57) ABSTRACT

A contour width setting device (1) in accordance with the present invention includes: a display size obtaining section (11) for obtaining a size of a display; a ratio calculating section (13); a line width calculating section (14); and a integer converting section (15), the ratio calculating section (13), the line width calculating section (14), and the integer converting section (15) being for setting a contour width of a character to be displayed on the display so as to be substantially inversely proportional to the size of the display which size is obtained by the display size obtaining section (11).

### TECHNICAL FIELD

The present invention relates to a counter width setting device and a contour width setting method each for setting a contour width of a character to be displayed on a display. Furthermore, the present invention relates to a contour gradation number setting device and a contour gradation number setting method each for setting contour gradation number of a character to be displayed on a display.

### BACKGROUND ART

In recent years, a large number of television receivers have been employing OSD display by which a character is displayed while being superimposed on a video. Examples of a character displayed as an OSD typically encompass characters constituting character information such as a channel call, program information, data broadcasting, and time.

In a case where a character is displayed as an OSD, a contour, having a color tone different from that of a stroke constituting the character, is often added to a periphery of the stroke. This is because, by adding such a contour to a stroke constituting a character, visibility of the character becomes hard to decrease even in a case where a color tone of the character matches a color tone of a video.

As a technique of displaying a character as a high-quality OSD, there are known techniques, for example, disclosed in Patent Literatures 1 through 3.

### CITATION LIST

Patent Literature 1

Japanese Patent Application Publication, Tokukai, No. 2007-232851 A (Publication Date: Sep. 13, 2007)

Patent Literature 2

Japanese Patent Application Publication, Tokukai, No. 2008-160345 A (Publication Date: Jul. 10, 2008)

Patent Literature 3

Japanese Patent Application Publication, Tokukai, No. 2009-194425 A (Publication Date: Aug. 27, 2009)

### SUMMARY OF INVENTION

### Technical Problem

However, in a case where a character is displayed on a display with the use of the conventional techniques, there is a problem as below that a display quality is deteriorated.

That is, in a case where a character is displayed on a display, the character is usually enlarged or reduced in size so that a relative size, corresponding to the display, of the character is a given size. In this case, a width of a contour added to the character is also enlarged or reduced in size together with a width of a stroke. This causes a physical width of the contour added to the character to be wider in a case where the character is displayed on a large-sized display, whereas this causes the physical width of the contour added to the character to be narrower in a case where the character is displayed on a small-sized display. Particularly, in a case where a multi-gradation contour is added to the character, a physical width of a belt-shaped region having an identical gradation (hereinafter, referred to as an “identical gradation region”) also becomes wider or narrower.

FIG. 13 is a view schematically illustrating characters displayed on displays with the use of the conventional techniques. As is clear from FIG. 13, a physical width of a contour added to each of the characters displayed on a 90-inch display is twice as wide as that of a contour added to each of the characters displayed on a 46-inch display, and is half again as wide as that of a contour added to each of the characters displayed on a 60-inch display.

In a case where a physical width of a contour is thus equal to or greater than a given width, this may cause a viewer to feel as if a display quality of a character was deteriorated. Such a feeling causes a diminishment of an added value that a large-sized display has, and should be therefore avoided at all costs. Furthermore, in a case where the physical width of the contour is equal to or narrower than the given width, this may causes a disappearance of an effect of the contour such that visibility of the character is increased. Such a phenomenon also leads to a deterioration of the display quality of the character, and should be therefore avoided at all costs.

FIG. 14 is a view schematically illustrating characters displayed on displays with the use of the conventional techniques. As is clear from FIG. 14, a physical width of a contour added to each of the characters displayed on a 90-inch display is twice as wide as that of a contour added to each of the characters displayed on a 46-inch display. According to FIG. 5, a three-gradation contour A2 is added, as the contour, to each of the characters. In this case, a physical width of each of identical gradation regions A21 through A23, corresponding to respective gradations, is also doubled.

In a case where a physical width of an identical gradation region constituting a multi-gradation contour is thus equal to or greater than a given width, this causes gradual changes in gradation to be recognized and may cause a viewer to feel as if a display quality of a character was deteriorated. Such a feeling causes a diminishment of an added value that a large-sized display has, and should be therefore avoided at all costs.

The present invention has been made in view of the above problems, and an object of the present invention is to realize a contour width setting device, a contour gradation number setting device, a contour width setting method, and a contour gradation number setting method each capable of displaying a high-quality character having a contour (for example, a character having a multi-gradation contour) on an any-sized display.

### Solution to Problem

In order to attain the above object, a contour width setting device in accordance with the present invention includes: a display size obtaining section for obtaining a size (a physical size measured in inches or the like) of a display; and a contour width setting section for setting a contour width (a logical size measured in dots or the like) of a character to be displayed on the display so that the contour width is substantially inversely proportional to the size of the display which size is obtained by the display size obtaining section.

In order to attain the above object, a contour gradation number setting device in accordance with the present invention includes: a display size obtaining section for obtaining a size (a physical size measured in inches or the like) of a display; a contour gradation number setting section for setting gradation number, which is the number of gradations of a contour added to a character to be displayed on the display, so that the gradation number is substantially proportional to the size of the display which size is obtained by the display size obtaining section.

In order to attain the above object, a contour width setting method in accordance with the present invention includes the steps of: (a) obtaining a size (a physical size measured in inches or the like) of a display; and (b) setting a contour width (a logical size measured in dots or the like) of a character to be displayed on the display so that the contour width is substantially inversely proportional to the size of the display which size is obtained in the step (a).

In order to attain the above object, a contour gradation number setting method in accordance with the present invention includes the steps of: (a) obtaining a size (a physical size measured in inches or the like) of a display; and (b) setting gradation number, which is the number of gradations of a contour added to a character to be displayed on the display, so that the gradation number is substantially proportional to the size of the display which size is obtained in the step (a).

### Advantageous Effects of Invention

According to the present invention, it is possible to cause a physical width of a contour added to a character to be substantially constant even in a case where the character is displayed on an any-sized display. Furthermore, according to the present invention, it is possible to cause a gradation density (the number of gradations per unit of length) of a contour added to a character to be substantially constant even in a case where the character is displayed on an any-sized display. It is therefore possible to display a high-quality character having a contour (for example, a character having a multi-gradation contour).

### BRIEF DESCRIPTION OF DRAWINGS

FIG. 1 is a block diagram illustrating a configuration of a contour width setting device in accordance with an embodiment of the present invention.

FIG. 2 is a flowchart illustrating a flow of a contour width setting method in accordance with the embodiment of the present invention.

FIG. 3 is a view schematically illustrating example operation of the contour width setting device illustrated in FIG. 1.

FIG. 4 is a block diagram illustrating a configuration of a television receiver including an OSD drawing section which serves as the contour width setting device illustrated in FIG. 1.

FIG. 5 is a view schematically illustrating an example of a screen which the television receiver illustrated in FIG. 4 displays on a display. (a) of FIG. 5 is a view schematically illustrating an example screen displayed while split screen display is being carried out. (b) of FIG. 5 is a view schematically illustrating an example screen displayed while PinP (Picture in Picture) display is being carried out.

FIG. 6 is a block diagram illustrating a configuration of a contour width setting device in accordance with an embodiment of the present invention.

(a) of FIG. 7 is a flowchart illustrating a flow of a contour width setting method in accordance with the embodiment of the present invention. (b) of FIG. 7 is a flowchart illustrating how to calculate a screen size ratio in the contour width setting method in accordance with the embodiment of the present invention.

FIG. 8 is a block diagram illustrating a configuration of a contour gradation number setting device in accordance with an embodiment of the present invention.

FIG. 9 is a flowchart illustrating a flow of a contour gradation number setting method in accordance with the embodiment of the present invention.

FIG. 10 is a view schematically illustrating example operation of the contour width setting device illustrated in FIG. 8.

FIG. 11 is a block diagram illustrating a configuration of a contour gradation number setting device in accordance with an embodiment of the present invention.
(a) of FIG. 12 is a flowchart illustrating a flow of a contour gradation number setting method in accordance with the embodiment of the present invention. (b) of FIG. 12 is a flowchart illustrating how to calculate a ratio of a screen size in the contour gradation number setting method in accordance with the embodiment of the present invention.

FIG. 13 is a view schematically illustrating characters displayed on displays with the use of conventional techniques.

FIG. 14 is a view schematically illustrating characters displayed on displays with the use of conventional techniques.

FIG. 15 is an appearance diagram illustrating an example configuration of the television receiver illustrated in FIG. 4. (a) of FIG. 15 is an appearance diagram illustrating the television receiver illustrated in FIG. 4 and a display connected to the television receiver. (b) of FIG. 15 is an appearance diagram illustrating a television set including the television receiver illustrated in FIG. 4 and a display. (c) of FIG. 15 is an appearance diagram illustrating the television set illustrated in (b) of FIG. 15 and a reproducing device connected to the television set.

### DESCRIPTION OF EMBODIMENTS

### Embodiment 1

The following description will discuss, with reference to the drawings, a contour width setting device in accordance with Embodiment 1 of the present invention.

Note that the contour width setting device in accordance with Embodiment 1 is a device for setting, to a width depending on a size of a display, a contour width of a character to be displayed on the display. The contour width setting device can be provided in, for example, receiver of a television broadcast (hereinafter, referred to as a “television receiver”). In this case, the contour width setting device in accordance with Embodiment 1 sets, depending on a size of a display embedded in or connected (by wire or wireless) to the television receiver, a contour width of a character to be displayed as an OSD on the display. Note that a contour width of a character indicates a line width of a contour added to a periphery of a stroke constituting the character.

[Configuration of Contour Width Setting Device 1]

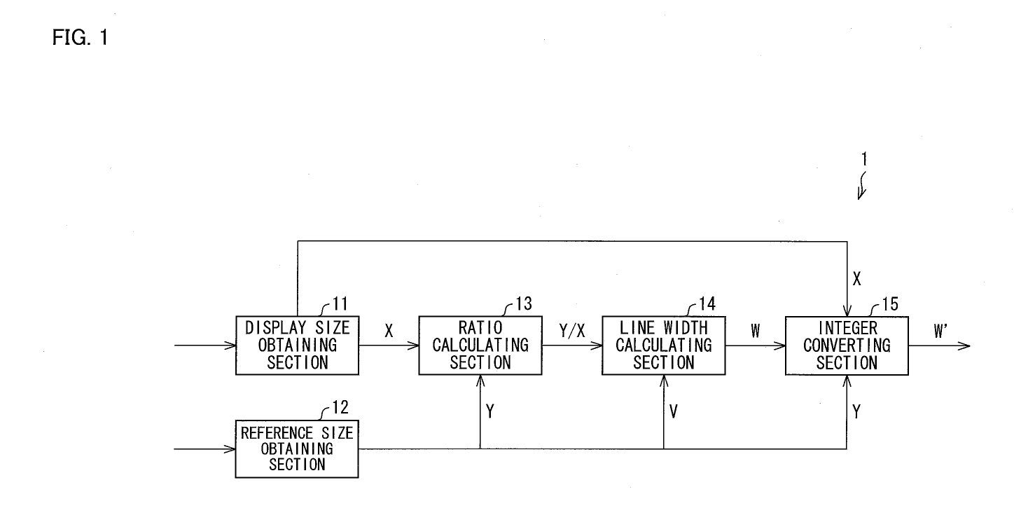

A configuration of a contour width setting device 1 in accordance with Embodiment 1 will be described below with reference to FIG. 1. FIG. 1 is a block diagram illustrating a configuration of a contour width setting device 1.

As illustrated in FIG. 1, the contour width setting device 1 includes a display size obtaining section 11, a reference size obtaining section 12, a ratio calculating section 13, a line width calculating section 14, and an integer converting section 15.

The display size obtaining section 11 obtains a target display size X. Note here that a “target display size” indicates a physical size of a display on which a character, having a contour width set by the contour width setting device 1, is displayed. The target display size X obtained by the display size obtaining section 11 is supplied to the ratio calculating section 13 (later described) and the integer converting section 15 (later described) as illustrated in FIG. 1. Note that the target display size X is represented by, for example, an integer in units of inches.

The reference size obtaining section 12 obtains a reference display size Y and a reference contour width V. Note here that a “reference display size” indicates a physical size of a display which is predetermined as a display that serves as a reference of screen design. Note also that a “reference contour width” indicates a logical size of a contour which is a predetermined as a contour that should be added to a character to be displayed on such a reference display. The reference display size Y obtained by the reference size obtaining section 12 is supplied to the ratio calculating section 13 (later described) and the integer converting section 15 (later described) as illustrated in FIG. 1. The reference contour width V obtained by the reference size obtaining section 12 is supplied to the line width calculating section 14 (later described) as illustrated in FIG. 1. Note that the reference display size Y is represented by, for example, an integer in units of inches and the reference contour width V is represented by, for example, an integer in units of dots.

The ratio calculating section 13 calculates a ratio Y/X of the reference display size Y to the target display size X. The ratio calculating section 13 calculates the ratio Y/X by, for example, dividing the reference display size Y supplied from the reference size obtaining section 12 by the target display size X supplied from the display size obtaining section 11. The ratio Y/X calculated by the ratio calculating section 13 is supplied to the line width calculating section 14 (later described) as illustrated in FIG. 1. Note that, for example, the ratio Y/X includes a decimal portion (having a given number of decimal places) in no unit.

The line width calculating section 14 calculates a contour width W=V*(Y/X) which is inversely proportional to the target display size X. The line width calculating section 14 calculates the contour width W=V*(Y/X) by, for example, multiplying the ratio Y/X supplied from the ratio calculating section 13 by the reference contour width V supplied from the reference size obtaining section 12. The contour width W calculated by the width calculating section 14 is supplied to the integer converting section 15 as illustrated in FIG. 1. Note that the contour width W indicates a logical size including a decimal portion (having a given number of decimal places) in units of dots.

The integer converting section 15 obtains a contour width W′ represented by an integer, by converting, into the integer, the contour width W including the decimal portion. The integer converting section 15 converts the contour width W into an integer, for example, in the following manner. That is, in a case where the target display size X is greater than the reference display size Y, the integer converting section 15 obtains the contour width W′ by rounding down a fraction portion of the contour width W. In a case where the target display size X is equal to or smaller than the reference display size Y, the integer converting section 15 obtains the contour width W′ by rounding up the fraction portion of the contour width W.

With the use of the contour width setting device 1, it is possible to set a contour width W′ of a character, to be displayed on a target display, to a width which is substantially inversely proportional (with integer accuracy) to a target display size X of the target display.

[Contour Width Setting Method]

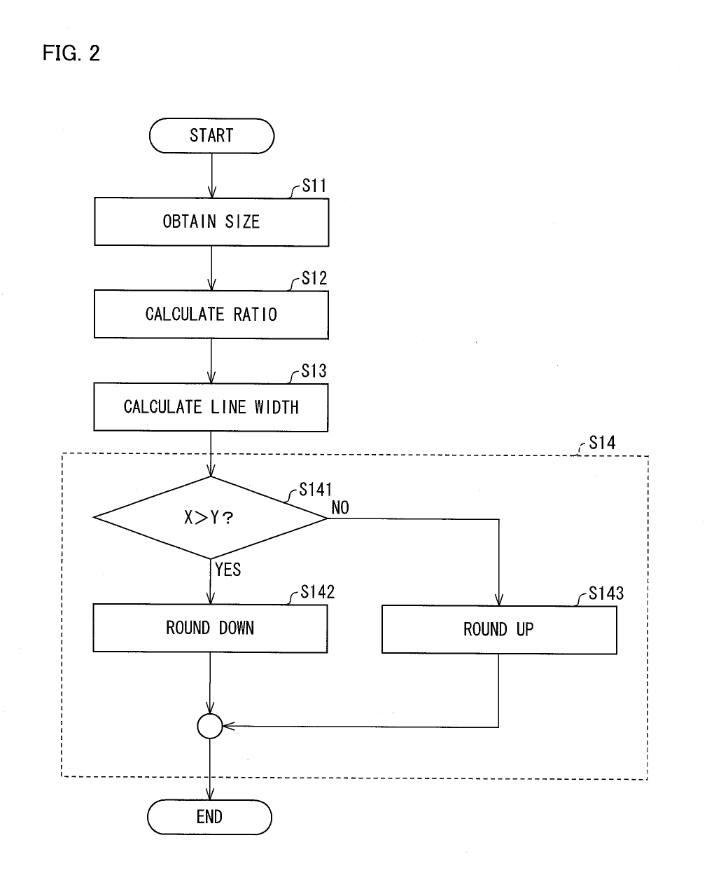

Next, a contour width setting method carried out by the contour width setting device 1 will be described below with reference to FIG. 2. FIG. 2 is a flowchart illustrating a flow of the contour width setting method.

As illustrated in FIG. 2, the contour width setting method includes a size obtaining step S11, a ratio calculating step S12, a line width calculating step S13, and an integer converting step S14.

The size obtaining step S11 is a step of obtaining a target display size X, a reference display size Y, and a reference contour width V. As has been described, the target display size X is obtained by the display size obtaining section 11. The reference display size Y and the reference contour width V are obtained by the reference size obtaining section 12.

The ratio calculating step S12 is a step of calculating a ratio Y/X from the target display size X and the reference display size Y obtained in the size obtaining step S11. As has been described, the ratio Y/X is calculated by the ratio calculating section 13.

The line width calculating step S13 is a step of calculating a contour width W from the reference contour width V obtained in the size obtaining step S11 and the ratio Y/X calculated in the ratio calculating step S12. As has been described, the contour width W is calculated by the line width calculating section 14.

The integer converting step S14 is a step of converting, into an integer, the contour width W calculated in the line width calculating step S13. As has been described, the contour width W is converted into an integer by the integer converting section 15. The integer converting step S14 includes, for example, a determining step S141, a rounding down step S142, and a rounding up step S143.

The determining step S141 is a step of comparing, in terms of size, the target display size X with the reference display size Y. In a case where the target display size X is greater than the reference display size Y, the integer converting section 15 carries out the rounding down step S142 (later described). In a case where the target display size X is equal to or smaller than the reference display size Y, the integer converting section 15 carries out the rounding up step S143 (later described).

The rounding down step S142 is a step of obtaining a contour width W′ represented by an integer, by rounding down a fraction portion of the contour width W. In a case where an integer portion of the contour width W is “n”, the contour width W′=n is obtained in the rounding down step S142.

The rounding up step S143 is a step of obtaining a contour width W′ represented by an integer, by rounding up a fraction portion of the contour width W. In a case where an integer portion of the contour width W is “n”, the contour width W′=n+1 is obtained in the rounding up step S143.

In accordance with the contour width setting method, it is possible to set a contour width W′ of a character, to be displayed on a target display, to a width which is substantially inversely proportional (with integer accuracy) to a target display size X of the target display.

Note that the contour width setting method is applicable to a method of manufacturing a television set (a television receiver in which a display is embedded). In this case, the contour width setting method is used to set a contour width of a character, to be displayed as an OSD on a display (hereinafter, referred to as an “internal display”) which is to be embedded in a television set to be manufactured, depending on a size of the internal display. The contour width set in accordance with the contour width setting method is recorded in, for example, a recording medium (hereinafter, referred to as an “internal recording medium”) which is to be embedded in the television set to be manufactured. According to the television set thus manufactured, it is possible to refer to the contour width which has been set in accordance with the contour width setting method and is recorded in the internal recording medium, in a case where a character is displayed as an OSD on the internal display.

Note that, in a case where the contour width setting method is applied to the method of manufacturing a television set, a manufacturing device which manufactures a television set (manufacturing device including the contour width setting device 1) can carry out each step of the contour width setting method. Alternatively, a manufacturer (operator) who manufactures a television set can carry out each step of the contour width setting method.

[Example Operation of Contour Width Setting Device 1]

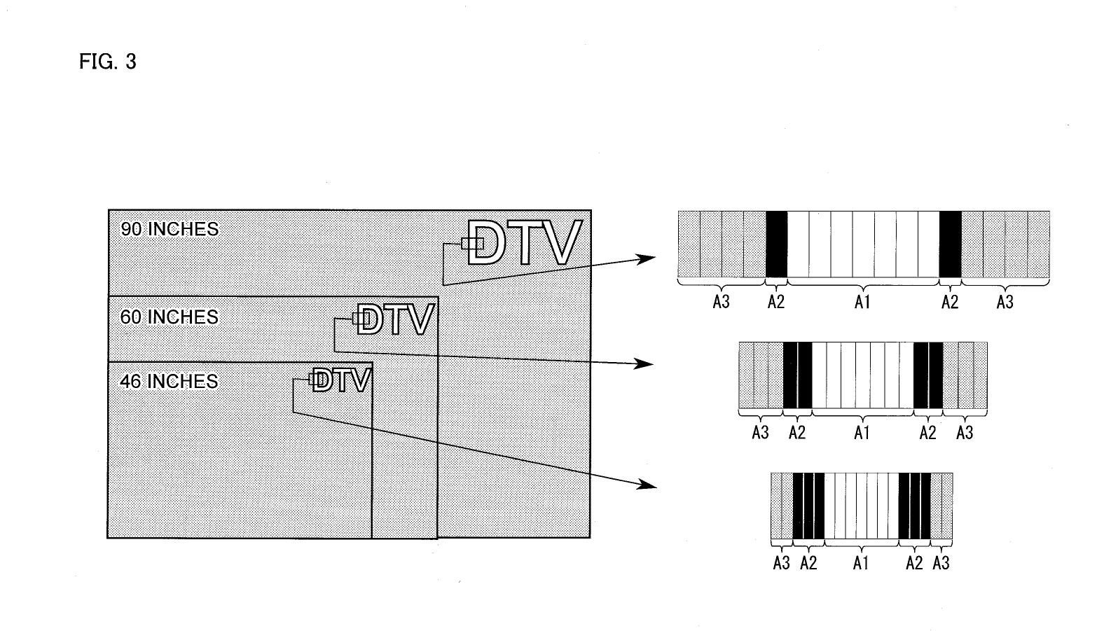

Next, example operation of the contour width setting device 1 will be described below with reference to FIG. 3. FIG. 3 is a view schematically illustrating example operation of the contour width setting device 1. In each enlarged view in FIG. 3, A1 indicates a region constituting a stroke, A2 indicates a region constituting a contour, and A3 indicates a region constituting a background.

The example operation is carried out so as to set a contour width of a character of 48 dots to be displayed on a display. According to this example, it is assumed that a reference display size Y is 60 inches and that a target display size X is 46 inches or 90 inches. Further, according to the example, it is assumed that the character of the 48 dots has a reference contour width V of 2 dots, that is, the character has a contour width of 2 dots in a case where the character is displayed on a 60-inch reference display.

In a case where the target display size X is 46 inches, the contour width setting device 1 calculates that (1) a ratio Y/X is nearly equal to 1.3 in the ratio calculating step S12, (2) a contour width W is equal to 2.6 in the line width calculating step S13, and (3) a contour width W′ is equal to 3 in the integer converting step S14. In this case, since the target display size X is equal to or smaller than the reference display size Y, the rounding up step S143 is carried out in the integer converting step S14. A physical width of a contour which is displayed on a 46-inch target display and which has a width of 3 dots is approximately 0.15 mm, which is substantially identical to a physical width (approximately 0.14 mm) of a contour which is displayed on the 60-inch reference display and which has a width of 2 dots.

In a case where the target display size X is 90 inches, the contour width setting device 1 calculates that (1) a ratio Y/X is nearly equal to 0.67 in the ratio calculating step S12, (2) a contour width W is equal to 1.3 in the line width calculating step S13, and (3) a contour width W′ is equal to 1 (one) in the integer converting step S14. In this case, since the target display size X is greater than the reference display size Y, the rounding down step S142 is carried out in the integer converting step S14. A physical width of a contour which is displayed on a 90-inch target display and which has a width of 1 (one) dot is approximately 0.10 mm, which is substantially identical to the physical width (approximately 0.14 mm) of the contour which is displayed on the 60-inch reference display and which has the width of 2 dots.

The following table shows a stroke width (in units of dots), a physical width of a stroke (in units of mm), a contour width (in units of dots), and a physical width of a contour (in units of mm) of a character displayed on each of a 46-inch display (target display), a 60-inch display (reference display), and a 90-inch display (target display).

TABLE 1

| | | | | | | |
|---|---|---|---|---|---|---|
| Display size | 46 | inches | 60 | inches | 90 | inches |
| Stroke width | 7 | dots | 7 | dots | 7 | dots |
| Physical width of | 0.35 | mm | 0.49 | mm | 0.70 | mm |
| stroke | | | | | | |
| Contour width | 3 | dots | 2 | dots | 1 | dot |
| Physical width of | 0.15 | mm | 0.14 | mm | 0.10 | mm |
| contour | | | | | | |

[Configuration of Television Receiver]

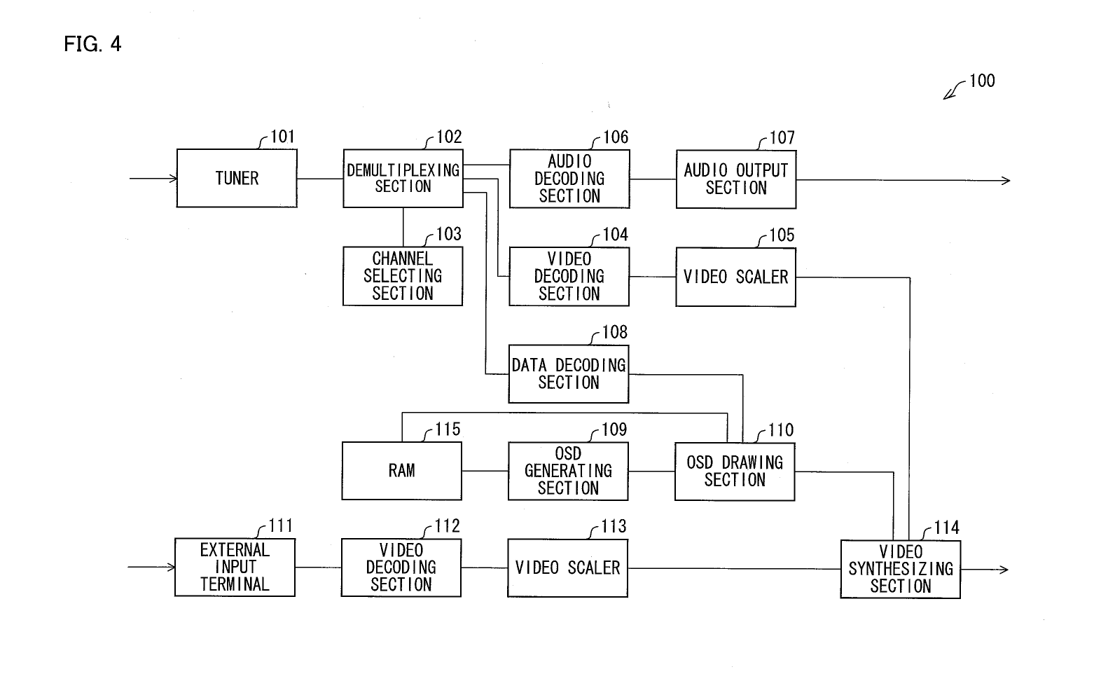

Next, a television receiver 100 including an OSD drawing section which serves as the contour width setting device 1 will be described below with reference FIG. 4. FIG. 4 is a block diagram illustrating a configuration of a television receiver 100.

As illustrated in FIG. 4, the television receiver 100 includes a tuner 101, a demultiplexing section 102, a channel selecting section 103, a video decoding section 104, a video scaler 105, an audio decoding section 106, an audio output section 107, a data decoding section 108, an OSD generating section 109, an OSD drawing section 110, an external input terminal 111, a video decoding section 112, a video scaler 113, a video synthesizing section 114, and an RAM 115. Out of those blocks, functions of blocks other than the OSD drawing section 110 are similar to those of blocks of a conventional television receiver. Therefore, the blocks other than the OSD drawing section 110 will not be described there.

The television receiver 100 is a receiver for receiving a television broadcast (a digital terrestrial broadcast, a BS broadcast, a CS broadcast, and the like), and is connected to an external display (not illustrated). The OSD drawing section 110 sets, depending on a size of the external display connected to the television receiver 100, a contour width of a character to be displayed as an OSD on the external display.

The external display can be connected to the television receiver 100 by wire via, for example, HDMI (registered trademark) or can be alternatively connected to the television receiver 100 by wireless via, for example, WiFi (registered trademark). In a case where the external display is connected to the television receiver 100 by wire, the television receiver 100 further includes (i) a communication section which generates an electric signal modulated by a video signal on which a character to be displayed as an OSD is superimposed and (ii) an output terminal via which the electric signal generated by the communication section is outputted outside. On the other hand, in a case where the external display is connected to the television receiver 100 by wireless, the television receiver 100 further includes (i) a communication section which generates an electric signal modulated by a video signal on which a character to be displayed as an OSD is superimposed and (ii) an antenna which converts, into an electromagnetic wave, the electric signal generated by the communication section.

Note that, in a case where the external display is connected to the television receiver 100 by wire, the television receiver 100 (i) obtains, from the external display, size information (EDID in a case of an HDMI connection) indicative of a size (target display size X) of the external display and (ii) stores, in the RAM 115, the size information thus obtained, at a time when a wired connection is established between the television receiver 100 and the external display. Note also that, in a case where the external display is connected to the television receiver 100 by wireless, the television receiver 100 (i) obtains, from the external display, size information indicative of a size (target display size X) of the external display and (ii) stores, in the RAM 115, the size information thus obtained, at a time when a wireless connection is established between the television receiver 100 and the external display (when the television receiver 100 is paired with the external display).

A reference display size Y and a reference contour width V are stored in the RAM 115 in advance before shipment. Therefore, after a connection is established between the television receiver 100 and the external display, the OSD drawing section 110 is capable of reading, from the RAM 115, the target display size X, the reference display size Y, and the reference contour width V at any timing.

The OSD drawing section 110 calculates a contour width W′ in accordance with the flowchart illustrated in FIG. 2. In this case, the OSD drawing section 110 reads, from the RAM 115, the target display size X, the reference display size Y, and the reference contour width V in the size obtaining step S11.

In a case where the OSD drawing section 110 receives a character code from the OSD generating section 109, the OSD drawing section 110 reads, from the RAM 115, a font corresponding to the character code, and generates a character image to be superimposed on a video signal. In this case, a line width of a contour added to a periphery of a stroke constituting a character contained in the character image is set to the contour width W′ which has been set as above. With this, even in case where the external display connected to the television receiver 100 is greater or smaller than a reference display, a character having a suitable contour width is always displayed on the external display.

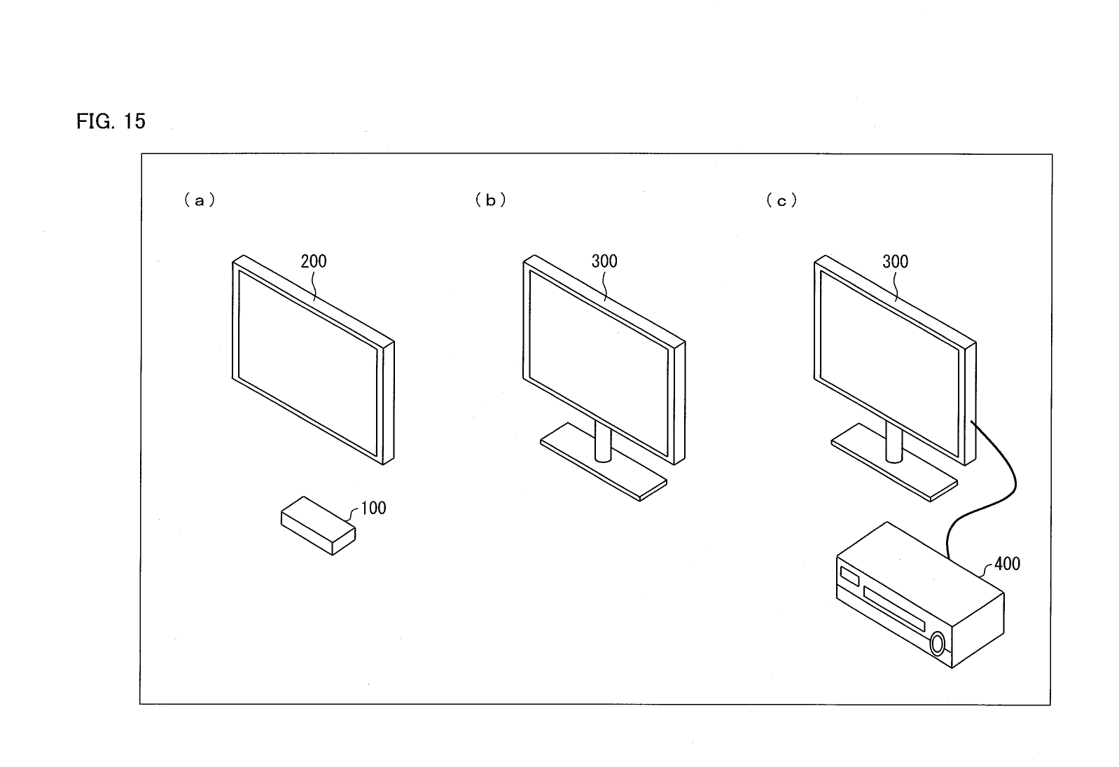

An example appearance of the television receiver 100 described here is as illustrated in (a) of FIG. 15. The television receiver 100 illustrated in (a) of FIG. 15 is used together with an external display 200, and sets a contour width of a character depending on a size of the external display 200. Note that the television receiver 100 illustrated in (a) of FIG. 15 is also referred to as, for example, a “tuner section”.

Note that Embodiment 1 has described a configuration in which an OSD drawing section included in a television receiver connected to a display (external display) is caused to serve as the contour width setting device 1. However, Embodiment 1 is not limited to such a configuration. That is, Embodiment 1 can employ a configuration in which an OSD drawing section included in a television receiver in which a display (internal display) is embedded (that is, a television set) is caused to serve as the contour width setting device 1. In this case, even in a case where an any-sized internal display is embedded in the television receiver, it is possible to display a character having a suitable contour width on the internal display without changing a function of the OSD drawing section serving as the contour width setting device 1. Particularly, (i) in a case where the function of the OSD drawing section serving as the contour width setting device 1 is implemented by software and (ii) even in a case where an any-sized internal display is embedded in the television receiver, it is possible to display a character having a suitable contour width on the internal display without changing a program for causing the OSD drawing section to serve as the contour width setting device 1.

An example appearance of the television set described here is as illustrated in (b) of FIG. 15. Note that a reference numeral 300 is given to the television set in (b) of FIG. 15.

Note also that Embodiment 1 has described a television receiver including an OSD drawing section serving as the contour width setting device 1. However, a device to which the contour width setting device 1 is provided is not limited to a television receiver. For example, the prevent invention is applicable to any device, even in a case where the any device does not have a function to receive a video, provided that the any device is a video outputting device that outputs a video on which a character is superimposed. Examples of the video output device encompass reproducing devices such as a DVD player and a BD player. In this case, a contour width of a character which is to be superimposed on a video to be outputted is set depending on a size of a display to which the video is supplied.

An example appearance of the reproducing device described here is as illustrated in (c) of FIG. 15. A reproducing device 400 illustrated in (c) of FIG. 15 is used together with the television set 300, and sets a contour width of a character depending on a size of a display included in the television set 300.

### Embodiment 2

The following description will discuss, with reference to the drawings, a contour width setting device in accordance with Embodiment 2 of the present invention.

Note that the contour width setting device in accordance with Embodiment 2 is a device for setting a contour width of a character, to be displayed on a display, to a width depending on both of a size of the display and a size of a screen displayed in reduced size on the display. The contour width setting device can be provided in, for example, a television receiver. Note here that a “size of a screen” indicates a logical size of a screen displayed in reduced size on a display, and is represented by, for example, a pair (horizontal pixel number X1, vertical pixel number Y1) of (i) the number of pixels horizontally arranged on the screen (horizontal pixel number X1) and (ii) the number of pixels vertically arranged on the screen (vertical pixel number Y1).

Examples of the screen displayed in reduced size on the display encompass (1) one of screens displayed while split screen display is being carried out and (2) a sub-screen displayed while PinP (Picture in Picture) display is being carried out.

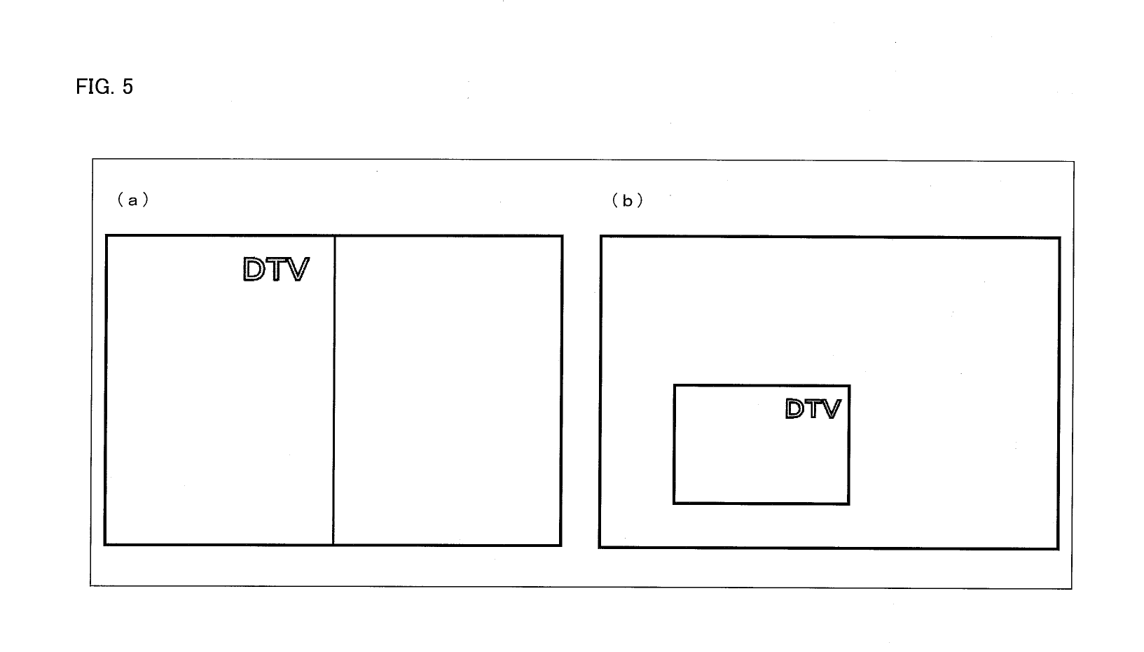

(a) of FIG. 5 is a front view illustrating a display observed while split screen display is being carried out. In this case, the contour width setting device in accordance with Embodiment 2 sets each contour width of characters “DTV”, to be displayed on a left screen which is displayed in reduced size on a left side of the display, depending on both of a physical size of the display and a logical size of the left screen.

(b) of FIG. 5 is a front view illustrating a display observed while the PinP display is being carried out. In this case, the contour width setting device in accordance with Embodiment 2 sets each contour width of characters “DTV”, to be displayed on a sub-screen which is displayed in reduced size on part of the display, depending on both of a physical size of the display and a logical size of the left screen.

[Configuration of Contour Width Setting Device 1′]

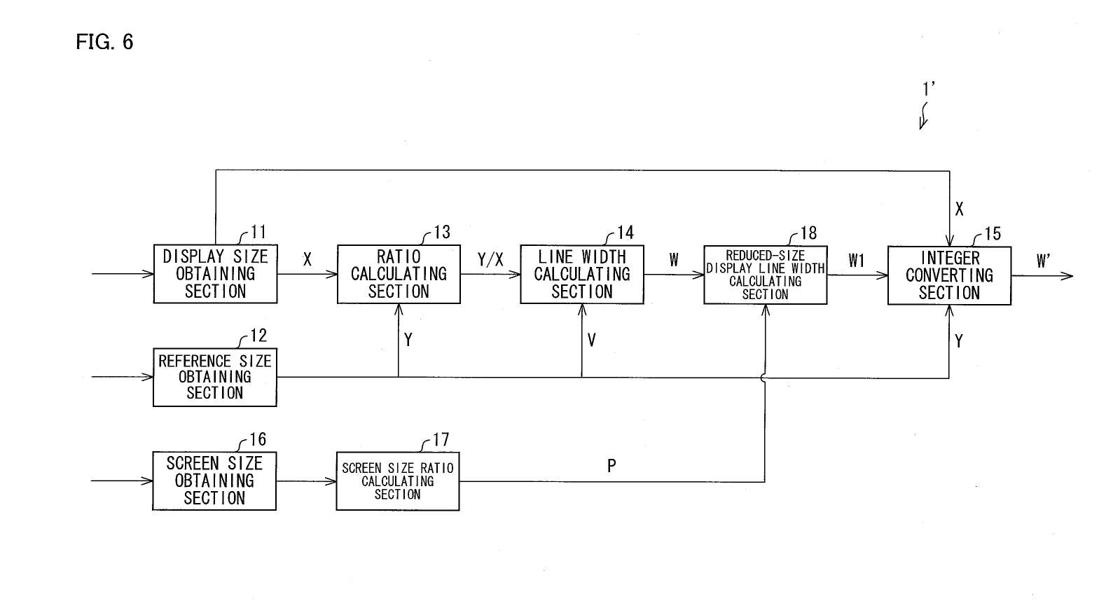

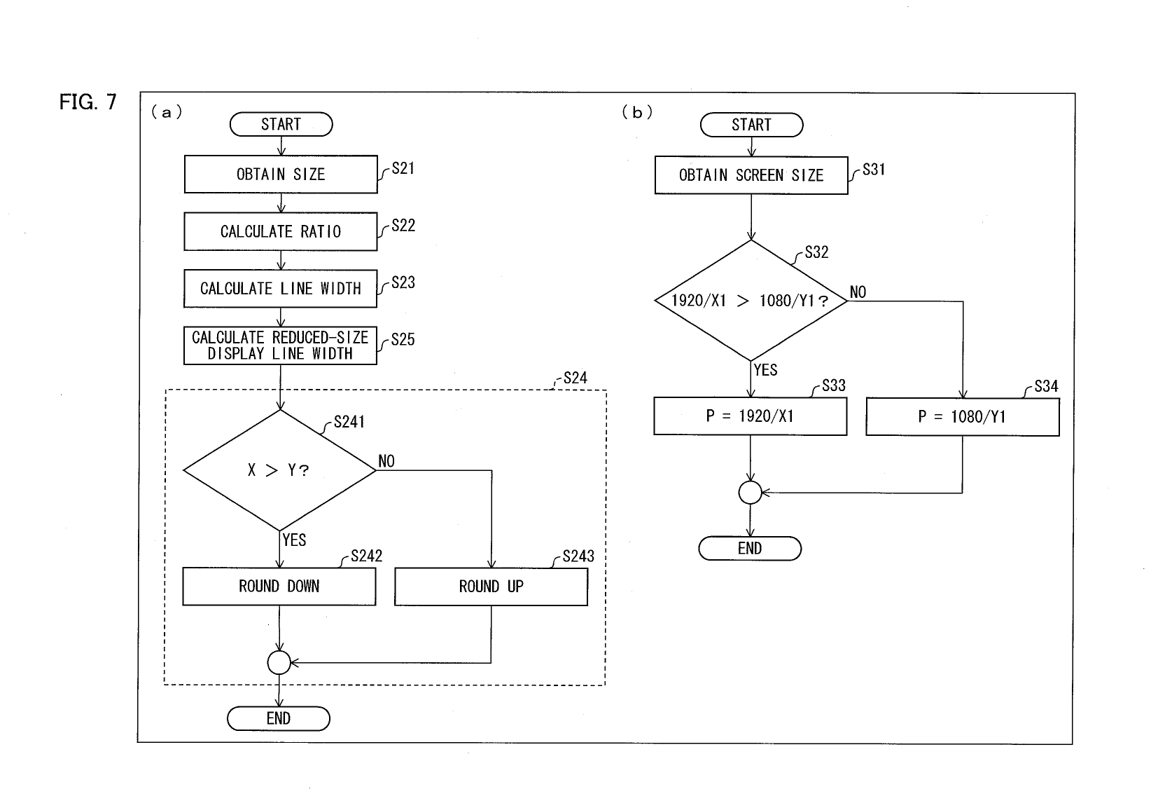

A configuration of a contour width setting device 1′ in accordance with Embodiment 2 will be described below with reference to FIG. 6. FIG. 6 is a block diagram illustrating a configuration of the contour width setting device 1′. Note that identical reference numerals will be given to respective members which have functions identical to those described in Embodiment 1, and the member will not be described here.

As illustrated in FIG. 6, in addition to the configuration of the contour width setting device 1 in accordance with Embodiment 1, the contour width setting device 1′ further includes a screen size obtaining section 16, a screen size ratio calculating section 17, an a reduced-size display line width calculating section 18.

The screen size obtaining section 16 obtains a size of a screen displayed in reduced size on a display (hereinafter, also referred to as a “reduced screen”). The screen size obtaining section 16 obtains a reduced screen size (X1, Y1) indicative of a size of the reduced screen. Furthermore, the screen size obtaining section 16 obtains a full screen size (X2, Y2) of the display. Note here that a “full screen size” indicates a logical size (for example, an integer in units of dots) of the display. In Embodiment 2, it is assumed that X2 is equal to 1920 dots and Y2 is equal to 1080 dots. The reduced screen size (X1, Y1) and the full screen size (X2, Y2) obtained by the screen size obtaining section 16 is supplied to the screen size ratio calculating section 17 (later described).

The screen size ratio calculating section 17 calculates a screen size ratio P indicative of a ratio of the reduced screen size to the full screen size of the display. The screen size ratio calculating section 17 calculates the screen size ratio P, for example, in the following manner. The screen size ratio calculating section 17 calculates (i) a quotient X2/X1 by dividing the horizontal pixel number X2 of the display by the horizontal pixel number X1 of the reduced screen and (ii) a quotient Y2/Y1 by dividing the vertical pixel number Y2 of the display by the vertical pixel number Y1 of the reduced screen. The screen size ratio calculating section 17 compares the quotient X2/X1 with the quotient Y2/Y1. In a case where the quotient X2/X1 is greater than the quotient Y2/Y1, the screen size ratio calculating section 17 sets the quotient X2/X1 as the screen size ratio P. In a case where the quotient X2/X1 is equal to or less than the quotient Y2/Y1, the screen size ratio calculating section 17 sets the quotient Y2/Y1 as the screen size ratio P. The screen size ratio P calculated by the screen size ratio calculating section 17 is supplied to the reduced-size display line width calculating section 18. Note that, for example, the screen size ratio P includes a decimal portion (having a given number of decimal places) in no unit.

A line width calculating section 14 calculates, as has been described in Embodiment 1, a contour width W=V*(Y/X) which is inversely proportional to a target display size X. In Embodiment 2, the contour width W calculated by the line width calculating section 14 is supplied to the reduced-size display line width calculating section 18 as illustrated in FIG. 6.

The reduced-size display line width calculating section 18 calculates a contour width W1=P*W which is inversely proportional to both of the target display size (X) and the reduced screen size (X1 or Y1). The reduced-size display line width calculating section 18 calculates the contour width W1=P*W by, for example, multiplying the contour width W, supplied from the line width calculating section 14, by the screen size ratio P supplied from the screen size ratio calculating section 17. The contour width W1 calculated by the reduced-size display line width calculating section 18 is supplied to an integer converting section 15 as illustrated in FIG. 6. Note that the contour width W1 indicates a logical size including a decimal portion (having a given number of decimal places) in units of dots.

In Embodiment 2, the integer converting section 15 obtains a contour width W′ represented by an integer, by converting, into the integer, the contour width W1 including the decimal portion. The integer converting section 15 converts the contour width W into an integer, for example, in the following manner. That is, in a case where the target display size X is greater than a reference display size Y, the integer converting section 15 obtains the contour width W′ by rounding down a fraction portion of the contour width W1. In a case where the target display size X is equal to or smaller than the reference display size Y, the integer converting section 15 obtains the contour width W′ by rounding up a fraction portion of the contour width W1.

With the use of the contour width setting device 1′, it is possible to set a contour width W′ of a character, to be displayed on a reduced screen, to a width which is substantially inversely proportional (with integer accuracy) to both of a target display size X of a target display and a size of the reduced screen (X1 or Y1) displayed on the target display.

[Contour Width Setting Method]

Next, a contour width setting method carried out by the contour width setting device 1′ will be described with reference to (a) of FIG. 7. (a) of FIG. 7 is a flowchart illustrating a flow of the contour width setting method.

As illustrated in (a) of FIG. 7, the contour width setting method includes a size obtaining step S21, a ratio calculating step S22, a line width calculating step S23, a reduced-size display line width calculating step S25, and an integer converting step S24.

The size obtaining step S21 is a step of obtaining a target display size X, a reference display size Y, and a reference contour width V. As has been described, the target display size X is obtained by a display size obtaining section 21. The reference display size Y and the reference contour width V are obtained by a reference size obtaining section 12.

The ratio calculating step S22 is a step of calculating a ratio Y/X from the target display size X and the reference display size Y obtained in the size obtaining step S21. As has been described, the ratio Y/X is calculated by a ratio calculating section 23.

The line width calculating step S23 is a step of calculating a contour width W from the reference contour width V obtained in the size obtaining step S21 and the ratio Y/X calculated in the ratio calculating step S22. As has been described, the contour width W is calculated by the line width calculating section 14.

The reduced-size display line width calculating step S25 is a step of calculating (i) a screen size ratio P (an inverse of a reduction rate) and (ii) a contour width W1=P*W which is inversely proportional to both of the target display size (X) and a reduced screen size (X1 or Y1). As has been described, the contour width W1 is calculated by the reduced-size display line width calculating section 18. Note that how to calculate the screen size ratio P will be described later with reference to another drawing.

The integer converting step S24 is a step of converting, into an integer, the contour width W1 calculated in the reduced-size display line width calculating step S25. As has been described, the contour width W1 is converted into an integer by the integer converting section 15. The integer converting step S24 includes, for example, a determining step S241, a rounding down step S242, and a rounding up step S243.

The determining step S241 is a step of comparing, in terms of size, the target display size X with the reference display size Y. In a case where the target display size X is greater than the reference display size Y, the integer converting section 15 carries out the rounding down step S242 (later described). In a case where the target display size X is equal to or smaller than the reference display size Y, the integer converting section 15 carries out the rounding up step S243 (later described).

The rounding down step S242 is a step of obtaining a contour width W′ represented by an integer, by rounding down a fraction portion of the contour width W1. In a case where an integer portion of the contour width W1 is “n”, the contour width W′=n is obtained in the rounding down step S242.

The rounding up step S243 is a step of obtaining a contour width W′ represented by an integer, by rounding up a fraction portion of the contour width W1. In a case where an integer portion of the contour width W1 is “n”, the contour width W′=n+1 is obtained in the rounding up step S243.

In accordance with the contour width setting method, it is possible to set a contour width W′ of a character, to be displayed on a reduced screen, to a width which is substantially inversely proportional (with integer accuracy) to both of a target display size X of a target display and a size of the reduced screen (X1 or Y1).

[Calculation of Screen Size Ratio]

Next, how to calculate a screen size ratio P in the reduced-size display line width calculating step S25 will be described below with reference to (b) of FIG. 7. (b) of FIG. 7 is a flowchart illustrating how to calculate a screen size ratio P in the contour width setting method.

A screen size obtaining step S31 is a step for obtaining a size of a screen displayed on a display. As has been described, such a screen size is obtained by the screen size obtaining section 16. The screen size obtaining section 16 obtains a full screen size and a reduced screen size in the screen size obtaining step S31. The full screen size and the reduced image size obtained in the screen size obtaining step S31 is supplied to the screen size ratio calculating section 17.

Each of steps S32 through 34 is a step for calculating a screen size ratio P indicative of a ratio of the reduced screen size to the full screen size of the display. As has been described, the steps S32 through S34 are carried out by the screen size ratio calculating section 17.

In the determining step S32, the screen size ratio calculating section 17 calculates (i) a quotient 1920/X1 by dividing 1920 horizontal pixels of the display by horizontal pixel number X1 of a reduced screen and (ii) a quotient 1080/Y1 by dividing 1080 vertical pixels of the display by vertical pixel number Y1 of the reduced screen. The screen size ratio calculating section 17 then compares the quotient 1920/X1 with the quotient 1080/Y1. In a case where the quotient 1920/X1 is greater than the quotient 1080/Y1, the screen size ratio calculating section 17 sets the quotient 1920/X1 as the screen size ratio P (setting step S33). In a case where the quotient 1920/X1 is equal to or less than the quotient 1080/Y1, the screen size ratio calculating section 17 sets the quotient 1080/Y1 as the screen size ratio P (setting step S34).

With the above procedure, the contour width setting device 1′ is capable of calculating a screen size ratio P.

Note that the contour width setting method is applicable to a method of manufacturing a television set, as well as the contour width setting method in accordance with Embodiment 1. In this case, the contour width setting method is used to set a contour width of a character, to be displayed as an OSD on an internal display of a television set to be manufactured, depending on both of a size of the internal display and a size of a reduced screen to be displayed on the internal display. The contour width set in accordance with the contour width setting method is recorded in, for example, an internal recording medium of the television set to be manufactured. According to the television set thus manufactured, it is possible to refer to the contour width which has been set in accordance with the contour width setting method and is recorded in the internal recording medium, in a case where a character is displayed as an OSD on the internal display.

Note that, in a case where the contour width setting method is applied to the method of manufacturing a television set, a manufacturing device which manufactures a television set (manufacturing device including the contour width setting device 1′) can carry out each step of the contour width setting method. Alternatively, a manufacturer (operator) who manufactures a television set can carry out each step of the contour width setting method.

[Configuration of Television Receiver]

Next, a television receiver 100 including an OSD drawing section which serves as the contour width setting device 1′ will be described below again with reference to FIG. 4. FIG. 4 is block diagram illustrating a configuration of the television receiver 100. Out of blocks included in the television receiver 100, functions of blocks other than an OSD drawing section 110 are similar to those described in Embodiment 1. Therefore, description of the blocks will be omitted.

As has been described, the television receiver 100 is a receiver for receiving a television broadcast and is connected to an external display (not illustrated). The OSD drawing section 110 in Embodiment 2 sets, depending on both of (i) a size of the external display connected to the television receiver 100 and (ii) a size of a reduced screen displayed on the external display, a contour width of a character to be displayed as an OSD on the external display.

The external display can be connected to the television receiver 100 by wire via, for example, HDMI or can be alternatively connected to the television receiver 100 by wireless via, for example, WiFi. In a case where the external display is connected to the television receiver 100 by wire, the television receiver 100 further includes (i) a communication section which generates an electric signal modulated by a video signal on which a character to be displayed as an OSD is superimposed and (ii) an output terminal via which the electric signal generated by the communication section is outputted outside. On the other hand, in a case where the external display is connected to the television receiver 100 by wireless, the television receiver 100 further includes (i) a communication section which generates an electric signal modulated by a video signal on which a character to be displayed as an OSD is superimposed and (ii) an antenna which converts, into an electromagnetic wave, the electric signal generated by the communication section.

Note that, in a case where the external display is connected to the television receiver 100 by wire, the television receiver 100 (i) obtains, from external display, (a) size information (EDID in a case of an HDMI connection) indicative of a size (target display size X) of the external display and (b) full screen size information indicative of a full screen size (X2, Y2) which is a logical size of the external display and (ii) stores, in an RAM 115, the size information and the full screen size information thus obtained, at a time when a wired connection is established between the television receiver 100 and the external display. Note also that, in a case where the external display is connected to the television receiver 100 by wireless, the television receiver 100 (i) obtains, from the external display, (a) size information indicative of a size (target display size X) of the external display and (b) full screen size information on the external display and (ii) stores, the RAM 115, the size information and the full screen size information thus obtained, at a time when a wireless connection is established between the television receiver 100 and the external display (when the television receiver 100 is paired with the external display).

A reference display size Y and a reference contour width V are stored in the RAM 115 in advance before shipment. Therefore, after a connection is established between the television receiver 100 and the external display, the OSD drawing section 110 is capable of reading, from the RAM 115, the target display size X, the reference display size Y, the full screen size (X2, Y2), and the reference contour width V at any timing.

In a case where the external display starts split screen display or PinP display, a video scaler 105, 113 reduces a size of a screen to be displayed on the external display. Reduced screen size information indicative of a reduced screen size (X 1, Y1) of the screen reduced in size by the video scaler 105, 113 is stored in the RAM 115. Therefore, after the external display starts the split screen display or the PinP display, the OSD drawing section 110 is capable of reading, from the RAM 115, the reduced screen size (X1, Y1) at any timing. Note that the OSD drawing section 110 can be configured to calculate a screen size ratio P upon receipt of, from the video scaler 105 or 113, a notification that the split screen display or the PinP display is started.

The OSD drawing section 110 calculates a contour width W′ in accordance with the flowchart illustrated in FIG. 7. In this case, the OSD drawing section 110 reads, from the RAM 115, the target display size X, the reference display size Y, and the reference contour width V in the size obtaining step S21. Further, the OSD drawing section 110 reads, from the RAM 115, the full screen size (X2, Y2) and the reduced screen size (X1, Y1) in the screen size obtaining step S31.

In a case where the OSD drawing section 110 receives a character code from an OSD generating section 109, the OSD drawing section 110 reads, from the RAM 115, a font corresponding to the character code, and generates a character image to be superimposed on a video signal. In this case, a line width of a contour added to a periphery of a stroke constituting a character contained in the character image is set to the contour width W′ which has been set as above. With this, even in case where the external display connected to the television receiver 100 is greater or smaller than a reference display, a character having a suitable contour width, corresponding to a size of a reduced screen displayed on the external display, is always displayed on the external display.

Note that Embodiment 2 has described a configuration in which an OSD drawing section included in a television receiver connected to an external display is caused to serve as the contour width setting device 1′. However, Embodiment 2 is not limited to such a configuration. That is, Embodiment 2 can employ a configuration in which an OSD drawing section included in a television receiver in which a display (internal display) is embedded (that is, a television set) is caused to serve as the contour width setting device 1′. In this case, even in a case where an any-sized internal display is embedded in the television receiver, it is possible to display a character having a suitable contour width on the internal display without changing a function of the OSD drawing section serving as the contour width setting device 1′. Particularly, (i) in a case where the function of the OSD drawing section serving as the contour width setting device 1′ is implemented by software and (ii) even in a case where an any-sized internal display is embedded in the television receiver, it is possible to display a character having a suitable contour width on the internal display without changing a program for causing the OSD drawing section to serve as the contour width setting device 1′.

Note also that Embodiment 2 has described a television receiver including an OSD drawing section serving as the contour width setting device 1′. However, a device to which the contour width setting device 1′ is provided is not limited to a television receiver. For example, the prevent invention is applicable to any device, even in a case where the any device does not have a function to receive a video, provided that the any device is a video outputting device that outputs a video on which a character is superimposed. Examples of the video output device encompass reproducing devices such as a DVD player and a BD player. In this case, a contour width of a character which is to be superimposed on a video to be outputted is set depending on (i) a size of a display to which the video is supplied and (ii) a size of a reduced screen displayed on the display.

Example appearances of the television receiver, the television set, and the reproducing device described here are similar to those illustrated in FIG. 15.

### Embodiment 3

The following description will discuss, with reference to the drawings, a contour gradation number setting device in accordance with Embodiment 3.

Note that the contour gradation number setting device in accordance with Embodiment 3 is a device for setting, to number depending on a size of a display, the number of gradations of a contour (hereinafter, also referred to as “contour gradation number”) added to a character to be displayed on the display. The contour gradation number setting device can be provided in, for example, a receiver of a television broadcast (hereinafter, referred to as a “television receiver”). In this case, the contour gradation number setting device in accordance with Embodiment 3 sets, depending on a size of a display embedded in or connected to (by wire or wireless) the television receiver, the number of gradations of a contour added to a character to be displayed as an OSD on the displayed.

[Configuration of Contour Gradation Number Setting Device]

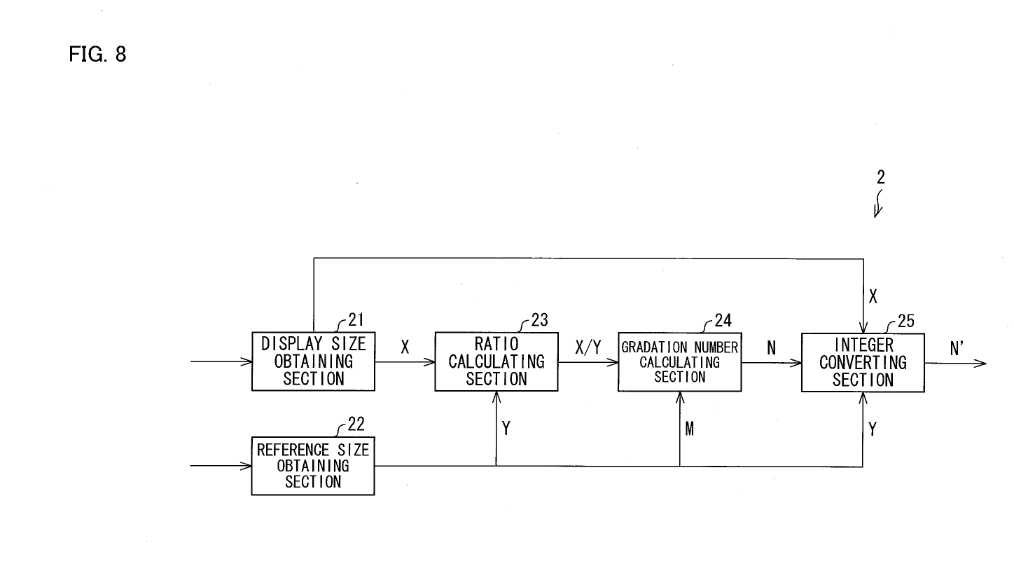

A configuration of the contour gradation number setting device 2 in accordance with Embodiment 3 will be described below with reference to FIG. 8. FIG. 8 is a block diagram illustrating a configuration of a contour gradation number setting device 2.

As illustrated in FIG. 8, the contour gradation number setting device 2 includes a display size obtaining section 21, a reference size obtaining section 22, a ratio calculating section 23, a gradation number calculating section 24, and an integer converting section 25.

The display size obtaining section 21 obtains a target display size X. Note that a “target display size” indicates a physical size of a display on which a character, having a contour that has gradations the number of which is set by the contour gradation number setting device 2, is displayed. The target display size X obtained by the display size obtaining section 11 is supplied to the ratio calculating section 23 (later described) and the integer converting section 25 (later described) as illustrated in FIG. 8. Note that the target display size X is represented by, for example, an integer in units of inches.

The reference size obtaining section 22 obtains a reference display size Y and reference contour gradation number M. Note here that a “reference display size” indicates a physical size of a display which is predetermined as a display that serves as a reference of screen design. Note also that “reference contour gradation number” indicates the number of gradations which is predetermined as the number of gradations of a contour added to a character to be displayed on such a reference display. The reference display size Y obtained by the reference size obtaining section 22 is supplied to the ratio calculating section 23 (later described) and the integer converting section 25 (later described) as illustrated in FIG. 8. The reference contour gradation number M obtained by the reference size obtaining section 22 is supplied to the gradation number calculating section 24 (later described) as illustrated in FIG. 8. Note that the reference display size Y is represented by, for example, an integer in units of inches, and the reference contour gradation number M is represented by, for example, an integer in units of no unit.

The ratio calculating section 23 calculates a ratio X/Y of the target display size X to the reference display size Y. The ratio calculating section 23 calculates the ratio X/Y by, for example, dividing the target display size X supplied from the display size obtaining section 21 by the reference display size Y supplied from the reference size obtaining section 22. The ratio X/Y calculated by the ratio calculating section 13 is supplied to the gradation number calculating section 24 (later described) as illustrated in FIG. 8. Note that, for example, the ratio X/Y includes a decimal portion (having a given number of decimal places) in no unit.

The gradation number calculating section 24 calculates contour gradation number N=M*(X/Y) which is proportional to the target display size X. The gradation number calculating section 24 calculates the contour gradation number N=M*(X/Y) by, for example, multiplying the ratio X/Y supplied from the ratio calculating section 23 by the reference contour gradation number M supplied from the reference size obtaining section 22. The contour gradation number N calculated by the gradation number calculating section 24 is supplied to the integer converting section 25 as illustrated in FIG. 8. Note that the contour gradation number N includes a decimal portion (having a given number of decimal places) in no unit.

The integer converting section 25 obtains contour gradation number N′ represented by an integer, by converting, into the integer, the contour gradation number N including the decimal portion. The integer converting section 25 converts the contour gradation number N into an integer, for example, in the following manner. That is, in a case where the target display size X is greater than the reference display size Y, the integer converting section 25 obtains the contour gradation number N′ by rounding up a fraction portion of the contour gradation number N. In a case where the target display size X is equal to or smaller than the reference display size Y, the integer converting section 25 obtains the contour gradation number N′ by rounding down the fraction portion of the contour gradation number N.

With the use of the contour gradation number setting device 2, it is possible to set contour gradation number N′ of a character, to be displayed on a target display, to number which is substantially proportional (with integer accuracy) to a target display size X of the target display.

[Contour Gradation Number Setting Method]

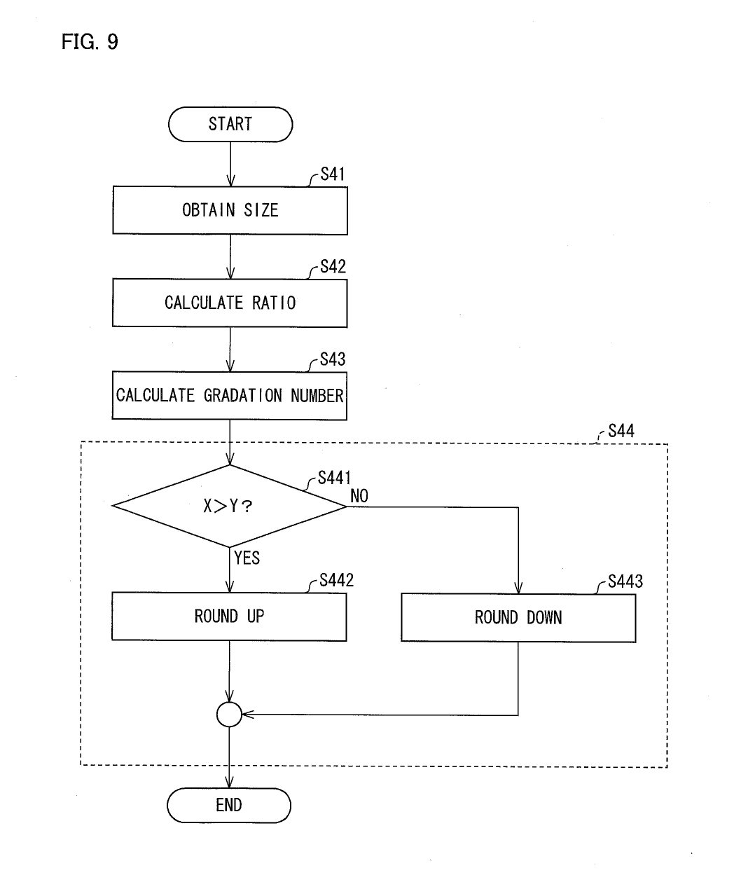

Next, a contour gradation number setting method carried out by the contour gradation number setting device 2 will be described below with reference to FIG. 9. FIG. 9 is a flowchart illustrating a flow of the contour gradation number setting method.

As illustrated in FIG. 9, the contour gradation number setting method includes a size obtaining step S41, a ratio calculating step S42, a gradation number calculating step S43, and an integer converting step S44.

The size obtaining step S41 is a step of obtaining a target display size X, a reference display size Y, and reference contour gradation number M. As has been described, the target display size X is obtained by the display size obtaining section 21. The reference display size Y and the reference contour gradation number M are obtained by the reference size obtaining section 22.

The ratio calculating step S42 is a step of calculating a ratio X/Y from the target display size X and the reference display size Y obtained in the size obtaining step S41. As has been described, the ratio X/Y is calculated by the ratio calculating section 23.

The gradation number calculating step S43 is a step of calculating contour gradation number N=M*(X/Y) from the reference contour gradation number M obtained in the size obtaining step S41 and the ratio X/Y calculated in the ratio calculating step S42. As has been described, the contour gradation number N is calculated by the gradation number calculating section 24.

The integer converting step S44 is a step of converting, into an integer, the contour gradation number N calculated in the gradation number calculating step S43. As has been described, the contour gradation number N is converted into an integer by the integer converting section 25. The integer converting step S44 includes, for example, a determining step S441, a rounding up step S442, and a rounding down step S443.

The determining step S441 is a step of comparing, in terms of size, the target display size X with the reference display size Y. In a case where the target display size X is greater than the reference display size Y, the integer converting section 25 carries out the rounding up step S442 (later described). In a case where the target display size X is equal to or smaller than the reference display size Y, the integer converting section 25 carries out the rounding down step S443 (later described).

The rounding up step S442 is a step of obtaining contour gradation number N′ represented by an integer, by rounding up a fraction portion of the contour gradation number N. In a case where an integer portion of the contour gradation number N is “n”, the contour gradation number N′=n+1 is obtained in the rounding up step S442.

The rounding down step S443 is a step of obtaining contour gradation number N′ represented by an integer, by rounding down a fraction portion of the contour gradation number N. In a case where an integer portion of the contour gradation number N is “n”, the contour gradation number N′=n is obtained in the rounding down step S443.

In accordance with the contour gradation number setting method, it is possible to set contour gradation number N′ of a character, to be displayed on a target display, to number which is substantially proportional (with integer accuracy) to a target display size X of the target display.

Note that the contour gradation number setting method is applicable to a method of manufacturing a television set (a television receiver in which a display is embedded). In this case, the contour gradation number setting method is used to set contour gradation number of a character, to be displayed as an OSD on a display (hereinafter, referred to as an “internal display”) which is to be embedded in a television set to be manufactured, depending on a size of the internal display. The contour gradation number set in accordance with the contour gradation number setting method is recorded in, for example, a recording medium (hereinafter, referred to as an “internal recording medium”) which is to be embedded in the television set to be manufactured. According to the television set thus manufactured, it is possible to refer to the contour gradation number which has been set in accordance with the contour gradation number setting method and which is recorded in the internal recording medium, in a case where a character is displayed as an OSD on the internal display.

Note that, in a case where the contour gradation number setting method is applied to the method of manufacturing a television set, a manufacturing device which manufactures a television set (manufacturing device including the contour gradation number setting device 2) can carry out each step of the contour gradation number setting method. Alternatively, a manufacturer (operator) who manufactures a television set can carry out each step of the contour gradation number setting method.

[Example Operation of Contour Gradation Number Setting Device]

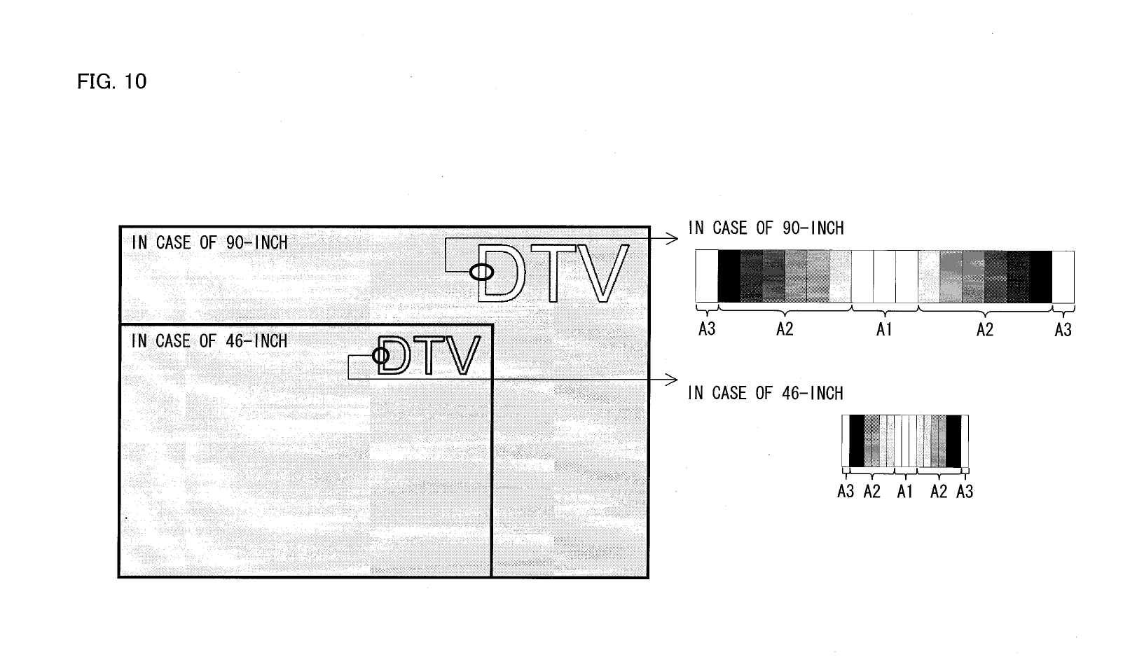

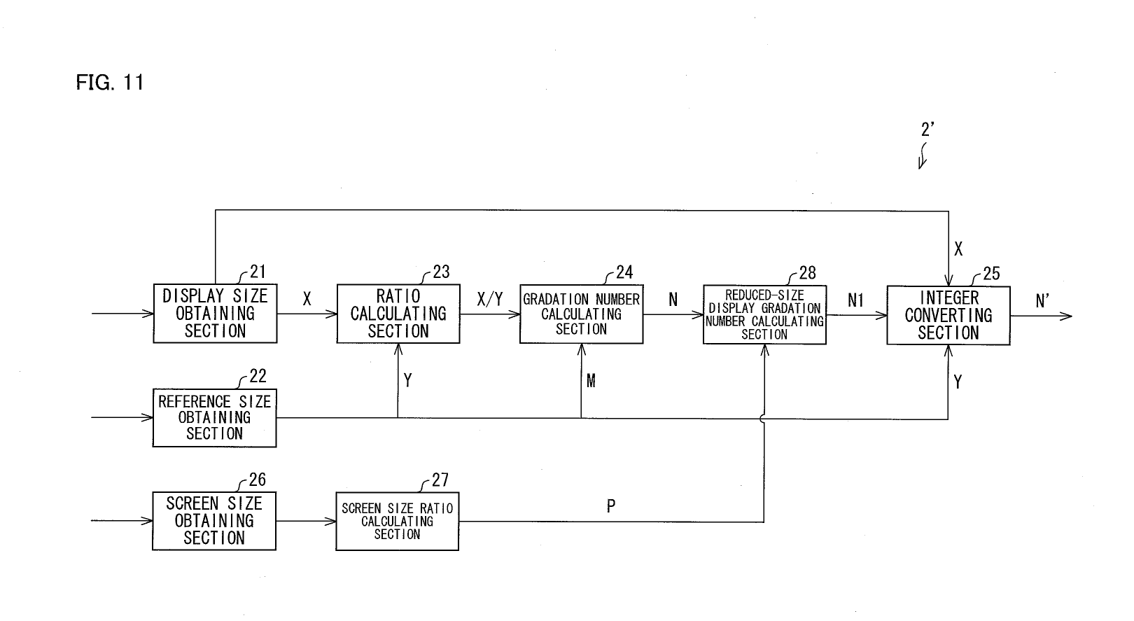

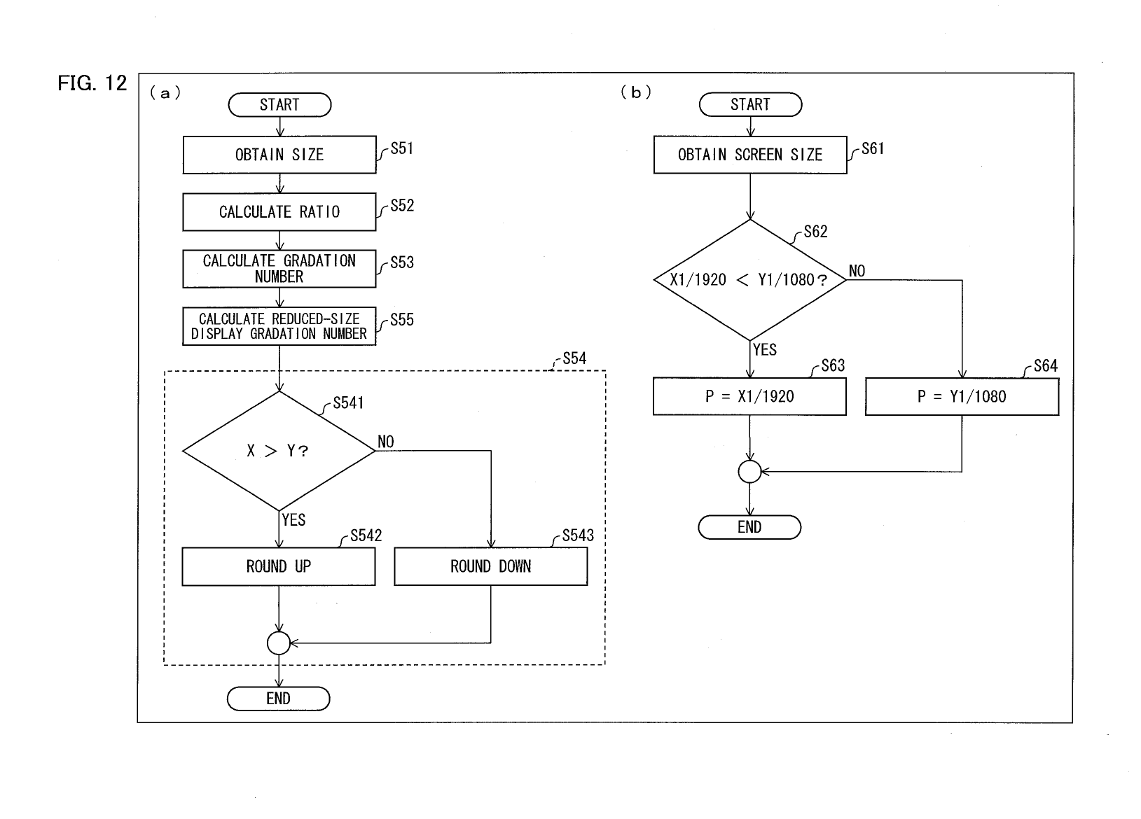

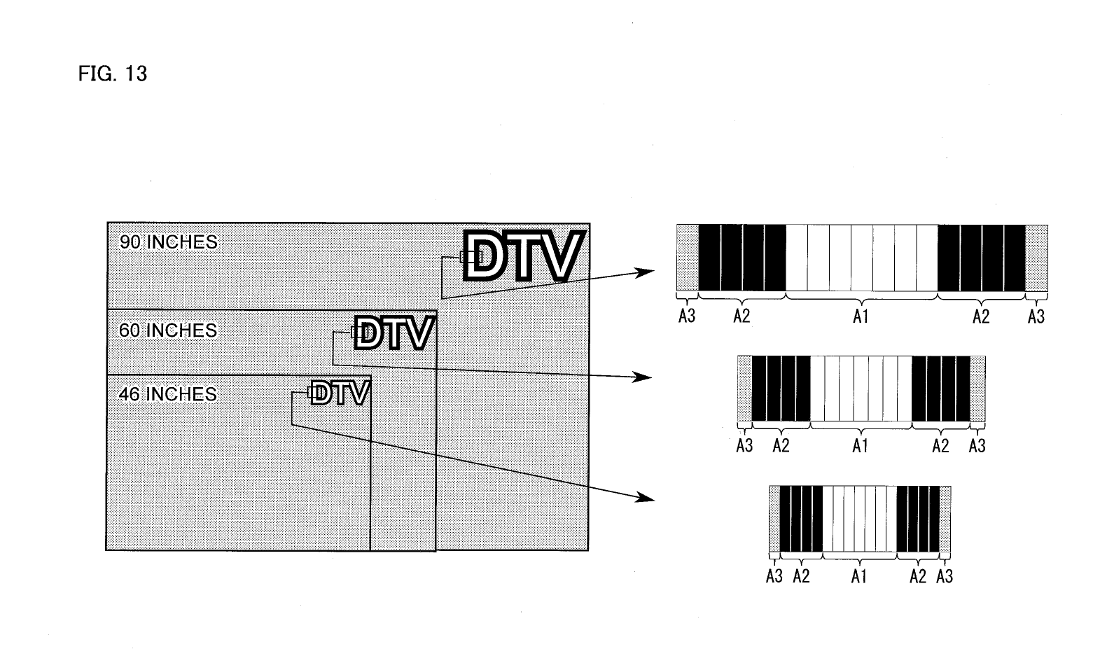

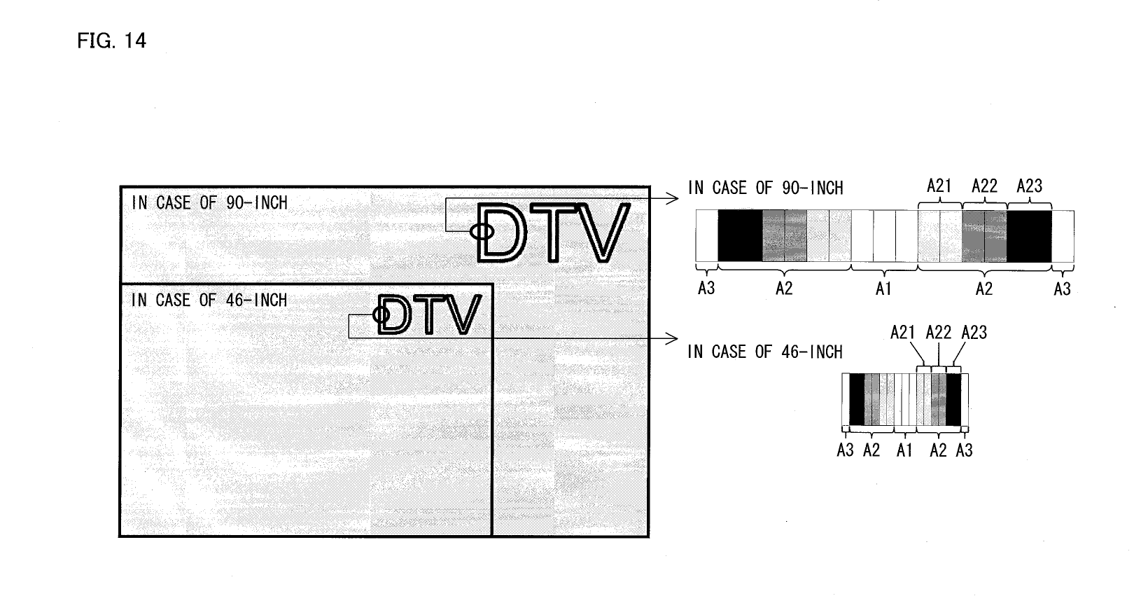

Next, example operation of the contour gradation number setting device 2 will be described below with reference to FIG. 10. FIG. 10 is a view schematically illustrating example operation of the contour gradation number setting device 2. In each enlarged view in FIG. 10, A1 indicates a region constituting a stroke, A2 indicates a region constituting a contour, and A3 indicates a region constituting a background.

The example operation is carried out so as to set contour gradation number of a character of 48 dots to be displayed on a display. According to this example, it is assumed that a reference display size Y is 60 inches and that a target display size X is 46 inches or 90 inches. Further, according to the example, it is assumed that, in a case where the character is displayed on a 60-inch reference display, the character has a contour width of 6 dots and contour gradation number (reference contour gradation number M) is 4 gradations.

In a case where the target display size X is 46 inches, the contour gradation number setting device 2 calculates that (1) a ratio X/Y is nearly equal to 0.77 in the ratio calculating step S42, (2) contour gradation number N is equal to 3.1 in the gradation number calculating step S43, and (3) contour gradation number N′ is equal to 3 in the integer converting step S44. In this case, since the target display size X is equal to or smaller than the reference display size Y, the rounding down step S443 is carried out in the integer converting step S44.

A physical width of a contour which is displayed on a 46-inch target display and which has a width of 6 dots is approximately 0.3 mm, whereas a physical width of a contour which is displayed on the 60-inch reference display and which has a width of 6 dots is approximately 0.4 mm. Therefore, a gradation density (the number of gradations per unit of length) of the contour displayed on the 46-inch target display is 10 gradations/mm, which is identical to a gradation density (10 gradations/mm) of the contour displayed on the 60-inch reference display.

In a case where the target display size X is 90 inches, the contour gradation number setting device 2 calculates that (1) a ration X/Y is nearly equal to 1.5 in the ratio calculating step S2, (2) contour gradation number N is equal to 6.0 in the gradation number calculating step S43, and (3) contour gradation number N′ is equal to 6 in the integer converting step S44. In this case, since the target display size X is greater than the reference display size Y, the rounding up step S442 is carried out in the integer converting step S4.

A physical width of a contour which is displayed on a 90-inch target display and which has a width of 6 dots is approximately 0.6 mm, whereas the physical width of the contour which is displayed on the 60-inch reference display and which has the width of 6 dots is approximately 0.4 mm. Therefore, a gradation density (the number of gradations per unit of length) of the contour displayed on the 90-inch target display is 10 gradations/mm, which is identical to the gradation density (10 gradations/mm) of the contour displayed on the 60-inch reference display.

The following table shows a contour width (in units of dots), a physical width of a contour (in units of mm), contour gradation number, and a gradation density (the number of gradations per 1 (one) mm) of the contour of a character displayed on each of a 46-inch display (target display), a 60-inch display (reference display), and a 90-inch display (target display).

TABLE 2

| | | | | | | |
|---|---|---|---|---|---|---|
| Screen size | 46 | inches | 60 | inches | 90 | inches |
| Contour width | 6 | dots | 6 | dots | 6 | dots |
| Physical width of | 0.3 | mm | 0.4 | mm | 0.6 | mm |
| contour | | | | | | |
| Gradation number | 3 | gradations | 4 | gradations | 6 | gradations |

| | | | |
|---|---|---|---|
| Gradation density | 10 | 10 | 10 |
| | gradations/mm | gradations/mm | gradations/mm |

[Configuration of Television Receiver]

Next, a television receiver 100 including an OSD drawing section which serves as the contour gradation number setting device 2 will be described below with reference to FIG. 4 again. FIG. 4 is a block diagram illustrating a configuration of a television receiver 100.

As illustrated in FIG. 4, the television receiver 100 includes a tuner 101, a demultiplexing section 102, a channel selecting section 103, a video decoding section 104, a video scaler 105, an audio decoding section 106, an audio output section 107, a data decoding section 108, an OSD generating section 109, an OSD drawing section 110, an external input terminal 111, a video decoding section 112, a video scaler 113, a video synthesizing section 114, and an RAM 115. Out of those blocks, functions of blocks other than the OSD drawing section 110 are similar to those of blocks of a conventional television receiver. Therefore, the blocks other than the OSD drawing section 110 will not be described there.

The television receiver 100 is a receiver for receiving a television broadcast (a digital terrestrial broadcast, a BS broadcast, a CS broadcast, and the like), and is connected to an external display (not illustrated). The OSD drawing section 110 sets, depending on a size of the external display connected to the television receiver 100, contour gradation number of a character to be displayed as an OSD on the external display.

The external display can be connected to the television receiver 100 by wire via, for example, HDMI (registered trademark) or can be alternatively connected to the television receiver 100 by wireless via, for example, WiFi (registered trademark). In a case where the external display is connected to the television receiver 100 by wire, the television receiver 100 further includes (i) a communication section which generates an electric signal modulated by a video signal on which a character to be displayed as an OSD is superimposed and (ii) an output terminal via which the electric signal generated by the communication section is outputted outside. On the other hand, in a case where the external display is connected to the television receiver 100 by wireless, the television receiver 100 further includes (i) a communication section which generates an electric signal modulated by a video signal on which a character to be displayed as an OSD is superimposed and (ii) an antenna which converts, into an electromagnetic wave, the electric signal generated by the communication section.

Note that, in a case where the external display is connected to the television receiver 100 by wire, the television receiver 100 (i) obtains, from the external display, size information (EDID in a case of an HDMI connection) indicative of a size (target display size X) of the external display and (ii) stores, in the RAM 115, the size information thus obtained, at a time when a wired connection is established between the television receiver 100 and the external display. Note also that, in a case where the external display is connected to the television receiver 100 by wireless, the television receiver 100 (i) obtains, from the external display, size information indicative of a size (target display size X) of the external display and (ii) stores, in the RAM 115, the size information thus obtained, at a time when a wireless connection is established between the television receiver 100 and the external display (when the television receiver 100 is paired with the external display).

A reference display size Y and reference contour gradation number M is stored in the RAM 115 in advance before shipment. Therefore, after a connection is established between the television receiver 100 and the external display, the OSD drawing section 110 is capable of reading, from the RAM 115, the target display size X, the reference display size Y, and the reference contour gradation number M at any timing.

The drawing section 110 calculates contour gradation number N′ in accordance with the flowchart illustrated in FIG. 9. In this case, the OSD drawing section 110 reads, from the RAM 115, the target display size X, the reference display size Y, and the reference contour gradation number M in the size obtaining step S41.

In a case where the OSD drawing section 110 receives a character code from the OSD generating section 109, the OSD drawing section 110 reads, from the RAM 115, a font corresponding to the character code, and generates a character image to be superimposed on a video signal. In this case, the number of gradations of a contour added to a periphery of a stroke constituting a character contained in the character image is set to the contour gradation number N′ which has been set as above. With this, even in case where the external display connected to the television receiver 100 is greater or smaller than a reference display, a character having suitable contour gradation number is always displayed on the external display.

Note that Embodiment 3 has described a configuration in which an OSD drawing section included in a television receiver connected to a display (external display) is caused to serve as the contour gradation number setting device 2. However, Embodiment 3 is not limited to such a configuration. That is, Embodiment 3 can employ a configuration in which an OSD drawing section included in a television receiver in which a display (internal display) is embedded (that is, a television set) is caused to serve as the contour gradation number setting device 2. In this case, even in a case where an any-sized internal display is embedded in the television receiver, it is possible to display a character having suitable contour gradation number on the internal display without changing a function of the OSD drawing section serving as the contour gradation number setting device 2. Particularly, (i) in a case where the function of the OSD drawing section serving as the contour gradation number setting device 2 is implemented by software and (ii) even in a case where an any-sized internal display is embedded in the television receiver, it is possible to display a character having suitable contour gradation number on the internal display without changing a program for causing the OSD drawing section to serve as the contour gradation number setting device 2.

Note also that Embodiment 3 has described a television receiver including an OSD drawing section serving as the contour gradation number setting device 2. However, a device to which the contour gradation number setting device 2 is provided is not limited to a television receiver. For example, the present invention is applicable to any device, even in a case where the any device does not have a function of receiving a video, provided that the any device is a video outputting device that outputs a video on which a character is superimposed. Examples of the video output device encompass reproducing devices such as a DVD player and a BD player. In this case, contour gradation number of a character which is to be superimposed on a video to be outputted is set depending on a size of a display to which the video is supplied.

Note that example appearances of the television receiver, the television set, and the reproducing device described here are similar to those illustrated in FIG. 15.

### Embodiment 4

The following description will discuss, with reference to the drawings, a contour gradation number setting device in accordance with Embodiment 4.

The contour gradation number setting device in accordance with Embodiment 4 is a device for setting the number of gradations of a contour (hereinafter, also referred to as “contour gradation number”) of a character, to be displayed on a display, to number depending on both of a size of the display and a size of a screen displayed in reduced size on the display. The contour gradation number setting device can be provided in, for example, a television receiver. Note here that a “size of a screen” indicates a logical size of a screen displayed in reduced size on a display, and is represented by, for example, a pair (horizontal pixel number X1, vertical pixel number Y1) of (i) the number of pixels horizontally arranged on the screen (horizontal pixel number X1) and (ii) the number of pixels vertically arranged on the screen (vertical pixel number Y1).

Examples of the screen displayed in reduced size on the display will be described below with reference to FIG. 5 again.

(a) of FIG. 5 is a front view illustrating a display observed while split screen display is being carried out. In this case, the contour gradation number setting device in accordance with Embodiment 4 sets contour gradation number of each of characters “DTV”, to be displayed on a left screen which is displayed in reduced size on a left side of the display, depending on both of a physical size of the display and a logical size of the left screen.

(b) of FIG. 5 is a front view illustrating a display observed while the PinP display is being carried out. In this case, the contour gradation number setting device in accordance with Embodiment 4 sets contour gradation number of each of characters “DTV”, to be displayed on a sub-screen which is displayed in reduced size on part of the display, depending on both of a physical size of the display and a logical size of the left screen.

[Configuration of Contour Gradation Number Setting Device 2′]

A configuration of a contour gradation number setting device 2′ in accordance with Embodiment 4 will be described below with reference to FIG. 11. FIG. 11 is a block diagram illustrating a configuration of the contour gradation number setting device 2′. Note that identical reference numerals will be given to respective members which have functions identical to those described in Embodiment 3, and the member will not be described here.

As illustrated in FIG. 11, in addition to the configuration of the contour gradation number setting device 2, the contour gradation number setting device 2′ further includes a screen size obtaining section 26, a screen size ratio calculating section 27, and a reduced-size display gradation number calculating section 28.

The screen size obtaining section 26 obtains a size of a screen displayed in reduced size on a display (hereinafter, also referred to as a “reduced screen”). The screen size obtaining section 26 obtains a reduced screen size (X1, Y1) indicative of a size of the reduced screen. Furthermore, the screen size obtaining section 26 obtains a full screen size (X2, Y2) of the display. Note here that a “full screen size” indicates a logical size (for example, an integer in units of dots) of the display. In Embodiment 4, it is assumed that X2 is equal to 1920 dots and Y2 is equal to 1080 dots. The reduced screen size (X1, Y1) and the full screen size (X2, Y2) obtained by the screen size obtaining section 26 is supplied to the screen size ratio calculating section 27 (later described).

The screen size ratio calculating section 27 calculates a screen size ratio P indicative of a ratio of the reduced screen size to the full screen size of the display. The screen size ratio calculating section 27 calculates the screen size ratio P, for example, in the following manner. The screen size ratio calculating section 27 calculates (i) a quotient X1/X2 by dividing the horizontal pixel number X1 of the reduced screen by the horizontal pixel number X2 of the display and (ii) a quotient Y1/Y2 by dividing the vertical pixel number Y1 of the reduced screen by the vertical pixel number Y2 of the display. The screen size ratio calculating section 27 compares the quotient X1/X2 with the quotient Y1/Y2. In a case where the quotient X1/X2 is less than the quotient Y1/Y2, the screen size ratio calculating section 27 sets the quotient X1/X2 as the screen size ratio P. In a case where the quotient X1/X2 is equal to or greater than the quotient Y1/Y2, the screen size ratio calculating section 27 sets the quotient Y1/Y2 as the screen size ratio P. The screen size ratio P calculated by the screen size ratio calculating section 27 is supplied to the reduced-size display gradation number calculating section 28. Note that, for example, the screen size ratio P includes a decimal portion (having a given number of decimal places) in no unit.

A gradation number calculating section 24 calculates, as has been described in Embodiment 3, contour gradation number N=M*(X/Y) which is proportional to a target display size X. In Embodiment 4, the contour gradation number N calculated by the gradation number calculating section 24 is supplied to the reduced-size display gradation number calculating section 28 as illustrated in FIG. 11.

The reduced-size display gradation number calculating section 28 calculates contour gradation number N1=P*N which is proportional to both of the target display size (X) and the reduced screen size (X1 or Y1). The reduced-size display gradation number calculating section 28 calculates the contour gradation number N1=P*N by, for example, multiplying the contour gradation number N, supplied from the gradation number calculating section 24, by the screen size ratio P supplied from the screen size ratio calculating section 27. The contour gradation number N1 calculated by the reduced-size display gradation number calculating section 28 is supplied to an integer converting section 25 as illustrated in FIG. 11. Note that the contour gradation number N1 includes a decimal portion (having a given number of decimal places) in no unit.

The integer converting section 25 obtains contour gradation number N′ represented by an integer, by converting, into the integer, the contour gradation number N1 including the decimal portion. The integer converting section 25 convers the contour gradation number N1 into an integer, for example, in the following manner. That is, in a case where the target display size X is greater than a reference display size Y, the integer converting section 25 obtains the contour gradation number N′ by rounding down a fraction portion of the contour gradation number N1.

With the use of the contour gradation number setting device 2′, it is possible to set contour gradation number N′ of a character, to be displayed on a target display, to number which is substantially proportional (with integer accuracy) to both of a target display size X of the target display and a reduced screen size (X1 or Y1).

[Contour Gradation Number Setting Method]

Next, a contour gradation number setting method carried out by the contour gradation number setting device 2 will be described below with reference to (a) of FIG. 12. (a) of FIG. 12 is a flowchart illustrating a flow of the contour gradation number setting method.

As illustrated in FIG. 12, the contour gradation number setting method includes a size obtaining step S51, a ratio calculating step S52, a gradation number calculating step S53, a reduced-size display gradation number calculating step S55, and an integer converting step S54.

The size obtaining step S51 is a step of obtaining a target display size X, a reference display size Y, and reference contour gradation number M. As has been described, the target display size X is obtained by a display size obtaining section 21. The reference display size Y and the reference contour gradation number M are obtained by a reference size obtaining section 22.

The ratio calculating step S52 is a step of calculating a ratio X/Y from the target display size X and the reference display size Y obtained in the size obtaining step S51. As has been described, the X/Y is calculated by a ratio calculating section 23.

The gradation number calculating step S53 is a step of calculating contour gradation number N=M*(X/Y) from the reference contour gradation number M obtained in the size obtaining step S51 and the ratio X/Y calculated in the ratio calculating step S52. As has been described, the contour gradation number N is calculated by the gradation number calculating section 24.

The reduced-size display gradation number calculating step S55 is a step of calculating (i) a screen size ratio P (a reduction rate) and (ii) contour gradation number N1=P*N which is proportional to both of the target display size (X) and a reduced screen size (X1, Y1). As has been described, a contour width W1 is calculated by the reduced-size display gradation number calculating section 28. Note that how to calculate the screen size ratio P will be described later with reference to another drawing.

The integer converting step S54 is a step of converting, into an integer, the contour gradation number N1 calculated in the reduced-size display gradation number calculating step S55. As has been described, the contour gradation number N1 is converted into an integer by the integer converting section 25. The integer converting step S54 includes, for example, a determining step S541, a rounding up step S542, and a rounding down step S543.

The determining step S541 is a step of comparing, in terms of size, the target display size X with the reference display size Y. In a case where the target display size X is greater than the reference display size Y, the integer converting section 25 carries out the rounding up step S542 (later described). In a case where the target display size X is equal to or smaller than the reference display size Y, the integer converting section 25 carries out the rounding down step S543 (later described).

The rounding up step S542 is a step of obtaining contour gradation number N′ represented by an integer, by rounding up a fraction portion of the contour gradation number N1. In a case where an integer portion of the contour gradation number N1 is “n”, the contour gradation number N′=n+1 is obtained in the rounding up step S542.

The rounding down step S543 is a step of obtaining contour gradation number N′ represented by an integer, by rounding down a fraction portion of the contour gradation number N1. In a case where an integer portion of the contour gradation number N1 is “n”, the contour gradation number N′=n is obtained in the rounding down step S543.

In accordance with the contour gradation number setting method, it is possible to set contour gradation number N′ of a character, to be displayed on a target display, to number which is substantially proportional (with integer accuracy) to a target display size X of the target display and a reduced screen size (X1 or Y1).

[Calculation of Screen Size Ratio]

Next, how to calculate a screen size ratio P in the reduced-size display gradation number calculating step S55 will be described below with reference to (b) of FIG. 12. (b) of FIG. 12 is a flowchart illustrating how to calculate a screen size ratio P in the contour width setting method.

A screen size obtaining step S61 is a step for obtaining a size of a screen displayed on a display. As has been described, such a screen size is obtained by the screen size obtaining section 26. The screen size obtaining section 26 obtains a full screen size and a reduced screen size in the screen size obtaining step S61. The full screen size and the reduced image size obtained in the screen size obtaining step S61 is supplied to the screen size ratio calculating section 27.

Each of steps S62 through S64 is a step for calculating a screen size ratio P indicative of a ratio of the reduced screen size to the full screen size of the display. As has been described, the steps S62 through S64 are carried out by the screen size ratio calculating section 27.

In the determining step S62, the screen size ratio calculating section 27 calculates (i) a quotient X1/1920 by dividing horizontal pixel number X1 of a reduced screen by 1920 horizontal pixels of the display and (ii) a quotient Y1/1080 by dividing vertical pixel number Y1 of the reduced screen by 1080 vertical pixels of the display. The screen size ratio calculating section 27 then compares the quotient X1/1920 with the quotient Y1/1080. In a case where the quotient X1/1920 is smaller than the quotient Y1/1080, the screen size ratio calculating section 27 sets the quotient X1/1920 as the screen size ratio P (setting step S63). In a case where the quotient X1/1920 is equal to or greater than the quotient Y1/1080, the screen size ratio calculating section 17 sets the quotient Y1/1080 as the screen size ratio P (setting step S64).

With the above procedure, the contour gradation number setting device 2′ is capable of calculating a screen size ratio P.

Note that the contour gradation number setting method is applicable to a method of manufacturing a television set, as well as the contour gradation number setting method in accordance with Embodiment 3. In this case, the contour gradation number setting method is used to set contour gradation number of a character, to be displayed as an OSD on an internal display of a television set to be manufactured, depending on both of a size pf the internal display and a size of a reduced screen to be displayed on the internal display. The contour gradation number set in accordance with the contour gradation number setting method is recorded in, for example, an internal recording medium of the television set to be manufactured. According to the television set thus manufactured, it is possible to refer to the contour gradation number which has been set in accordance with the contour gradation number setting method and is recorded in the internal recording medium, in a case where a character is displayed as an OSD on the internal display.

Note that, in a case where the contour gradation number setting method is applied to the method of manufacturing a television set, a manufacturing device which manufactures a television set (manufacturing device including the contour gradation number setting device 2′) can carry out each step of the contour gradation number setting method. Alternatively, a manufacturer (operator) who manufactures a television set can carry out each step of the contour gradation number setting method.

[Configuration of Television Receiver]

Next, a television receiver 100 including an OSD drawing section which serves as the contour gradation number setting device 2′ will be described below again with reference to FIG. 4. FIG. 4 is block diagram illustrating a configuration of the television receiver 100. The television receiver 100 of Embodiment 4 is different from that described in Embodiment 2 in that an OSD drawing section 110 serves as the contour gradation number setting device 2′. That is, the OSD drawing section 110 sets gradation contour number of a character, to be displayed as an OSD on an external display connected to the television receiver 100, depending on both of a size of the external display and a size of a reduced screen displayed on the external display.

The OSD drawing section 110 calculates contour gradation number N′ in accordance with the flowchart illustrated in FIG. 12. In this case, in the size obtaining step S51, the OSD drawing section 110 reads, from a RAM 115, a target display size X, a reference display size Y, and reference contour gradation number M (these data are stored in the RAM 115 in advance before shipment). In the screen size obtaining step S61, the OSD drawing section 110 reads, from the RAM 115, a full screen size (X2, Y2) and a reduced screen size (X1, Y1).

In a case where the OSD drawing section 110 receives a character code from an OSD generating section 109, the OSD drawing section 110 reads, from the RAM 115, a font corresponding to the character code, and generates a character image to be superimposed on a video signal. In this case, the number of gradations of a contour added to a periphery of a stroke constituting a character contained in the character image is set to the contour gradation number N′ which has been set as above. With this, even in case where the external display connected to the television receiver 100 is greater or smaller than a reference display, a character having suitable contour gradation number, corresponding to a size of a reduced screen displayed on the external display, is always displayed on the external display.

Note that example appearances of the television receiver, the television set, and the reproducing device described here are similar to those illustrated in FIG. 15.

[Software Implementation Example]

Finally, each block of the contour width setting device 1, the contour width setting device 1′, the contour gradation number setting device 2, and the contour gradation number setting device 2′ can be implemented by hardware such as a logic circuit provided on an integrated circuit (IC chip) or can alternatively be implemented by software with the use of a CPU (Central Processing Unit).

In the latter case, each of the contour width setting devices 1 and 1′ and the contour gradation number setting device 2 and 2′ includes: a CPU which executes instructions of a program that carries out the foregoing functions; and a storage device (recording medium) such as a ROM (Read Only Memory) which stores therein the program, a RAM (Random Access Memory) in which the program is loaded, and a memory that stores the program and various sets of data. The object of the present invention can be attained by (i) supplying, to each of the contour width setting devices 1 and 1′ and the contour gradation number setting devices 2 and 2′, the recoding medium in which program codes (an executable program, an intermediate code program, and a source program) of a program for controlling the contour width setting devices 1 and 1′ and the contour gradation number setting devices 2 and 2′, each of which is implemented by software that executes the foregoing functions, are computer-readably recorded and (ii) causing a computer (or a CPU or an MPU) of the each of the contour width setting devices 1 and 1′ and the contour gradation number setting devices 2 and 2′ to read and execute the program codes recorded in the recording medium.

Examples of the recording medium includes non-transitory tangible mediums, for example, (i) tapes such as a magnetic tape and a cassette tape; (ii) disks including magnetic disks, such as a floppy (Registered Trademark) disk and a hard disk, and optical disks, such as a CD-ROM, an MO, an MD, a DVD, and a CD-R; (iii) cards such as an IC card (including a memory card) and an optical card; (iv) semiconductor memories such as a mask ROM, EPROM, EEPROM (Registered Trademark), and a flash ROM; and (v) logic circuits such as a PLD (Programmable Logic Device) and an FPGA (Field Programmable Gate Array).

Each of the contour width setting device 1 and 1′ and the contour gradation number setting device 2 and 2′ can be connected to a communication network so that the program codes are supplied to the each of the contour width setting device 1 and 1′ and the contour gradation number setting device 2 and 2′ via the communication network. This communication network is not limited to any particular one, provided that the program codes can be transmitted. Examples of the communication network include the Internet, an intranet, an extranet, a LAN, ISDN, VAN, a CATV communications network, a virtual private network, a telephone network, a mobile telecommunications network, and a satellite communication network. Further, a transmission medium by which the communication network is constituted is not limited to any particular one, provided that the program codes can be transmitted. Examples of the transmission medium include: wired transmission media such as IEEE1394, a USB, a power-line carrier, a cable TV circuit, a telephone line, and ADSL (Asymmetric Digital Subscriber Line); and wireless transmission media such as infrared communication systems such as IrDA and a remote control, Bluetooth (Registered Trademark), IEEE802.11 wireless communication system, HDR (High Digital Rate), NFC (Near Field Communication), DLNA (Digital Living Network Alliance), a mobile phone network, a satellite circuit, and a digital terrestrial network. Note that the present invention can also be implemented in a form of a computer data signal in which the program codes are embodied by an electronic transmission and which is embedded in carrier waves.

[Summary]

A contour width setting device (1) in accordance with an aspect of the present invention includes: a display size obtaining section (11) for obtaining a size of a display; and a contour width setting section (13, 14, 15) for setting a contour width of a character to be displayed on the display so that the contour width is substantially inversely proportional to the size of the display which size is obtained by the display size obtaining section (11).

According to the above configuration, it is possible to cause a physical width of a contour added to a character to be substantially constant even in a case where the character is displayed on an any-sized display. This allows a high-quality character having a contour to be displayed.

The contour width setting device (1) in accordance with an aspect of the present invention is preferably arranged such that the contour width setting section (13, 14, 15) includes: a contour width calculating section (13, 14) for calculating a contour width W=V*(Y/X) including a decimal portion; and a contour width integer converting section (15) for calculating a contour width W′ represented by an integer, by converting, into the integer, the contour width W calculated by the contour width calculating section (13, 14), where: X denotes the size of the display which size is obtained by the display size obtaining section (11); Y denotes a size of a reference display which is a predetermined display; and V denotes a width of a reference contour which is a predetermined contour.

According to the above configuration, it is possible to rapidly derive, with a simple configuration, a contour width which is substantially inversely proportional to a size of a display.

The contour width setting device (1) in accordance with an aspect of the present invention is preferably arranged such that the contour width integer converting section (15) calculates that (1) the contour width W′ is “n” in a case where the size X of the display is greater than the size Y of the reference display and that (2) the contour width W′ is n+1 in a case where the size X of the display is smaller than the size Y of the reference display, where “n” denotes an integer portion of the contour width W calculated by the contour width calculating section (13, 14).

According to the above configuration, it is possible to convert, into an integer, a contour width to be set, without causing a problem that a contour width of a character to be displayed on a display greater in size than a reference display becomes too wide or without causing a problem that a contour width of a character to be displayed on a display smaller in size than a reference display becomes too narrow.

The contour width setting device (1′) in accordance with an aspect of the present invention is preferably arranged so as to include: a screen size obtaining section (16) for obtaining a size of a screen displayed in reduced size on the display, the contour width setting section (13, 14, 15, 18) setting the contour width of the character to be displayed on the display so that the contour width is substantially inversely proportional to both of (i) the size of the display which size is obtained by the display size obtaining section (11) and (ii) the size of the screen which size is obtained by the screen size obtaining section (16).

According to the above configuration, it is possible to cause a physical width of a contour added to a character to be substantially constant even in a case where the character is displayed on a screen displayed in reduced size on a display. This allows a high-quality character having a contour to be displayed.

The contour width setting device (1′) in accordance with an aspect of the present invention is preferably arranged such that: the screen size obtaining section (16) obtains (I) the number X1 of pixels horizontally arranged on the screen which is displayed in reduced size on the display and (II) the number Y1 of pixels vertically arranged on the screen which is displayed in reduced size on the display; and the contour width setting section (13, 14, 15, 18) includes: a contour width calculating section (13, 14, 18) for calculating a contour width W1=P*V*(Y/X) including a decimal portion, with the use of (1) (X2/X1) set as a screen size ratio P in a case where (X2/X1) is greater than (Y2/Y1) or (2) (Y2/Y1) set as the screen size ratio P in a case where (X2/X1) is smaller than (Y2/Y1); and a contour width integer converting section (15) for calculating a contour width W′ represented by an integer, by converting, into the integer, the contour width W1 calculated by the contour width calculating section (13, 14, 18), where X2 denotes the number of pixels horizontally arranged on the display and Y2 denotes the number of pixels vertically arranged on the display.

According to the above configuration, it is possible to set a suitable screen size ratio P even in a case where a screen is displayed in reduced size on a display so that an aspect ratio of the screen is changed. This allows a high-quality character having a contour to be displayed.

A contour width setting method in accordance with an aspect of the present invention includes the steps of: (a) obtaining a size of a display (S11); and (b) setting a contour width of a character to be displayed on the display (S12, S13, S14) so that the contour width is substantially inversely proportional to the size of the display which size is obtained in the step (a) (S11).

According to the above configuration, it is possible to cause a physical width of a contour added to a character to be substantially constant even in a case where the character is displayed on an any-sized display. This allows a high-quality character having a contour to be displayed.

Note that the scope of the present invention also encompasses a television receiver (100) including a contour width setting device (1, 1′, 110) recited above, the television receiver (100) setting, with the use of the contour width setting device (1, 1′, 110), a contour width of a character to be displayed as an OSD on a display connected to or embedded in the television receiver.

Further, the scope of the present invention also encompasses a method of manufacturing a television set, including the method of setting a contour width of a character, which method is used to set a contour width of a character to be displayed as an OSD on a display embedded in a television receiver.

Further, the scope of the present invention also encompasses (i) a program for causing a computer to function as each section (11, 13, 14, 15, 16, 17, 18) of the contour width setting device (1, 1′) and (ii) a computer-readable rerecording medium in which the program is recorded.

A contour gradation number setting device (2) in accordance with an aspect of the present invention includes: a display size obtaining section (21) for obtaining a size of a display; a contour gradation number setting section (23, 24, 25) for setting contour gradation number of a character, to be displayed on the display, so that the contour gradation number is substantially proportional to the size of the display which size is obtained by the display size obtaining section (21).

According to the above configuration, it is possible to cause a gradation density (the number of gradations per unit of length) of a contour added to a character to be substantially constant even in a case where the character is displayed on an any-sized display. This allows a high-quality character having a multi-gradation contour to be displayed.

The contour gradation number setting device (2) in accordance with an aspect of the present invention is preferably arranged such that the contour gradation number setting section (23, 24, 25) includes: a contour gradation number calculating section (23, 24) for calculating gradation number N=M*(X/Y) including a decimal portion; and a contour gradation number integer converting section (25) for calculating gradation number N′ represented by an integer, by converting, into the integer, the gradation number N calculated by the contour gradation number calculating section, where: X denotes the size of the display which size is obtained by the display size obtaining section (21); Y denotes a size of a reference display which is a predetermined display; and M denotes the number of gradations of a reference contour which is a predetermined contour.

According to the above configuration, it is possible to rapidly derive, with a simple configuration, the number of gradations which number substantially proportional to a size of a display.

The contour gradation number setting device (2) in accordance with an aspect of the present invention is preferably arranged such that the contour gradation number integer converting section (25) calculates that (1) the gradation number N′ is n+1 in a case where the size X of the display is greater than the size Y of the reference display and that (2) the gradation number N′ is “n” in a case where the size X of the display is smaller than the size Y of the reference display, where “n” denotes an integer portion of the gradation number N which number is calculated by the contour gradation number calculating section (23, 24).

According to the above configuration, it is possible to convert, into an integer, the number of gradations to be set, without causing a problem that a gradation density of a character to be displayed on a display greater in size than a reference display becomes too low or without causing a problem that a gradation density of a character to be displayed on a display smaller in size than a reference display becomes too high.

The contour gradation number setting device (2′) in accordance with an aspect of the present invention is preferably arranged so as to include: a screen size obtaining section (26) for obtaining a size of a screen displayed in reduced size on the display, the contour gradation number setting section (23, 24, 25, 28) setting the gradation number, which is the number of the gradations of the contour added the character to be displayed on the display, so that the gradation number is substantially proportional to both of (i) the size of the display which size is obtained by the display obtaining section (21) and (ii) the size of the screen which size is obtained by the screen size obtaining section (26).

According to the above configuration, it is possible to cause a gradation density (the number of gradations per unit of length) of a contour added to a character to be substantially constant even in a case where the character is displayed on a screen displayed in reduced size on a display. This allows a high-quality character having a multi-gradation contour to be displayed.

The contour gradation number setting device (2′) in accordance with an aspect of the present invention is preferably arranged such that: the screen size obtaining section (26) obtains (I) the number X1 of pixels horizontally arranged on the screen which is displayed in reduced size on the display and (II) the number Y1 of pixels vertically arranged on the screen which is displayed in reduced size on the display; and the contour gradation number setting section (23, 24, 25, 28) includes: a contour width calculating section (23, 24, 28) for calculating gradation number N1=P*M*(X/Y) including a decimal portion, with the use of (1) (X1/X2) set as a screen size ratio P in a case where (Y1/Y2) is greater than (X1/X2) or (2) (Y1/Y2) set as the screen size ratio P in a case where (Y1/Y2) is smaller than (X1/X2); and a contour gradation number integer converting section (25) for calculating the gradation number N′ represented by an integer, by converting, into the integer, the gradation number N1 calculated by the contour width calculating section (23, 24, 28).

According to the above configuration, it is possible to set a suitable screen size ratio P even in a case where a screen is displayed in reduced size on a display so that an aspect ratio of the screen is changed. This allows a high-quality character having a contour to be displayed.

A method of setting the number of gradations of a contour of a character in accordance with an aspect of the present invention includes the steps of: (a) obtaining a size of a display (S41); and (b) setting gradation number (S42, S43, S44), which is the number of gradations of a contour added to a character to be displayed on the display, so that the gradation number is substantially proportional to the size of the display which size is obtained in the step (a) (S41).

According to the above configuration, it is possible to cause a gradation density (the number of gradations per unit of length) of a contour added to a character to be substantially constant even in a case where the character is displayed on an any-sized display. This allows a high-quality character having a multi-gradation contour to be displayed.

Note that the scope of the present invention also encompasses a television receiver (100) including a contour gradation number setting device (2, 2′, 110) recited above, the television receiver (100) setting, with the use of the contour gradation number setting device (2, 2′, 110), gradation number which is the number of gradations of a contour added to a character to be displayed as an OSD on a display connected to or embedded in the television receiver (100).

Further, the scope of the present invention also encompasses a method of manufacturing a television set, including the method of setting the number of gradations of a contour of a character, which method is used to set the number of gradations of a contour added to a character to be displayed as an OSD on a display embedded in a television receiver.

Further, the scope of the present invention also encompasses (i) a program for causing a computer to function as each section (21, 23, 24, 25, 26, 27, 28) of the contour gradation number setting device (2, 2′) and (ii) a computer-readable rerecording medium in which the program is recorded.

[Supplementary Note]

The present invention is not limited to the description of the embodiments, but may be altered by a skilled person in the art within the scope of the claims. An embodiment derived from a proper combination of technical means disclosed in different embodiments is also encompassed in the technical scope of the present invention. Further, a new technical feature can be formed by a combination of technical means disclosed in embodiments.

### INDUSTRIAL APPLICABILITY

The present invention is applicable to various types of audio visual equipment which display a character as an OSD on a display. For example, the present invention is applicable to a television receiver, a television set, a BD player, and a DVD player.

### REFERENCE SIGNS LIST

1 Contour width setting device
11 Display size obtaining section
12 Reference size obtaining section
13 Ratio calculating section
14 Line width calculating section
15 Integer converting section
16 Screen size obtaining section
17 Screen size ratio calculating section
18 Reduced-size display line width calculating section
100 Television receiver
110 OSD drawing section (contour width setting device, contour gradation number setting device)
2 Contour gradation number setting device
21 Display size obtaining section
22 Reference size obtaining section
23 Ratio calculating section
24 Gradation number calculating section
25 Integer converting section
26 Screen size obtaining section
27 Screen size ratio calculating section
28 Reduced-size display gradation number calculating section

1. A device comprising:
a display size obtaining section for obtaining a size of a display
in accordance with (i) the size of the display which size is obtained by the display size obtaining section, (ii) a size of a reference display which is a predetermined display, and (iii) a width of a reference contour which is a predetermined contour, the device displaying, on the display, a character having a contour width that is substantially inversely proportional to the size of the display which size is obtained by the display size obtaining section.

2. The device as set forth in claim 1 further comprising:
a contour width calculating section for calculating a contour width W=V*(Y/X) including a decimal portion; and
a contour width integer converting section for calculating a contour width W′ represented by an integer, by converting, into the integer, the contour width W calculated by the contour width calculating section,
where: X denotes the size of the display which size is obtained by the display size obtaining section; Y denotes the size of the reference display which is a predetermined display; and V denotes the width of the reference contour which is a predetermined contour.

3. The device as set forth in claim 2, wherein
the contour width integer converting section calculates that (1) the contour width W′ is “n” in a case where the size X of the display is greater than the size Y of the reference display and that (2) the contour width W′ is n+1 in a case where the size X of the display is smaller than the size Y of the reference display,
where “n” denotes an integer portion of the contour width W calculated by the contour width calculating section.

4. The device as set forth in claim 1, further comprising:
a screen size obtaining section for obtaining a size of a screen displayed in reduced size on the display,
the device setting the contour width of the character to be displayed on the display so that the contour width is substantially inversely proportional to both of (i) the size of the display which size is obtained by the display size obtaining section and (ii) the size of the screen which size is obtained by the screen size obtaining section.

5. The device as set forth in claim 4, wherein the screen size obtaining section obtains (I) the number X1 of pixels horizontally arranged on the screen which is displayed in reduced size on the display and (II) the number Y1 of pixels vertically arranged on the screen which is displayed in reduced size on the display
the device further comprising:
a contour width calculating section for calculating a contour width W1=P*V*(Y/X) including a decimal portion, with the use of (1) (X2/X1) set as a screen size ratio P in a case where (X2/X1) is greater than (Y2/Y1) or (2) (Y2/Y1) set as the screen size ratio P in a case where (X2/X1) is smaller than (Y2/Y1); and
a contour width integer converting section for calculating a contour width W′ represented by an integer, by converting, into the integer, the contour width W1 calculated by the contour width calculating section,
where X2 denotes the number of pixels horizontally arranged on the display and Y2 denotes the number of pixels vertically arranged on the display.

6. A television receiver comprising a device recited in claim 1,
the television receiver displaying, as an OSD on a display connected to or embedded in the television receiver, a character having a contour width that is substantially inversely proportional to a size of the display.

7. A contour gradation number setting device comprising:
a display size obtaining section for obtaining a size of a display;
a contour gradation number setting section for setting gradation number, which is the number of gradations of a contour added to a character to be displayed on the display, so that the gradation number is substantially proportional to the size of the display which size is obtained by the display size obtaining section.

8. The contour gradation number setting device as set forth in claim 7, wherein the contour gradation number setting section includes: a contour gradation number calculating section for calculating gradation number N=M*(X/Y) including a decimal portion; and a contour gradation number integer converting section for calculating gradation number N′ represented by an integer, by converting, into the integer, the gradation number N calculated by the contour gradation number calculating section,
where: X denotes the size of the display which size is obtained by the display size obtaining section; Y denotes a size of a reference display which is a predetermined display; and M denotes the number of gradations of a reference contour which is a predetermined contour.

9. The contour gradation number setting device as set of forth in claim 8, wherein the contour gradation number integer converting section calculates that (1) the gradation number N′ is n+1 in a case where the size X of the display is greater than the size Y of the reference display and that (2) the gradation number N′ is “n” in a case where the size X of the display is smaller than the size Y of the reference display,
where “n” denotes an integer portion of the gradation number N which number is calculated by the contour gradation number calculating section.

10. The contour gradation number setting device as set forth in claim 7, further comprising:
a screen size obtaining section for obtaining a size of a screen displayed in reduced size on the display,
the contour gradation number setting section setting the gradation number, which is the number of the gradations of the contour added the character to be displayed on the display, so that the gradation number is substantially proportional to both of (i) the size of the display which size is obtained by the display obtaining section and (ii) the size of the screen which size is obtained by the screen size obtaining section.

11. The contour gradation number setting device as set forth in claim 10, wherein:
the screen size obtaining section obtains (1) the number X1 of pixels horizontally arranged on the screen which is displayed in reduced size on the display and (II) the number Y1 of pixels vertically arranged on the screen which is displayed in reduced size on the display; and
the contour gradation number setting section includes: a gradation number calculating section for calculating gradation number N1=P*M*(X/Y) including a decimal portion, with the use of (1) (X1/X2) set as a screen size ratio P in a case where (Y1/Y2) is greater than (X1/X2) or (2) (Y1/Y2) set as the screen size ratio P in a case where (Y1/Y2) is smaller than (X1/X2); and a contour gradation number integer converting section for calculating the gradation number N′ represented by an integer, by converting, into the integer, the gradation number N1 calculated by the gradation number calculating section.

12. A television receiver comprising a contour gradation number setting device recited in claim 7,
the television receiver setting, with the use of the contour gradation number setting device, gradation number which is the number of gradations of a contour added to a character to be displayed as an OSD on a display connected to or embedded in the television receiver.

13. A method comprising the steps of:
(a) obtaining a size of a display; and
(b) displaying, on the display, a character having a contour width that is substantially inversely proportional to the size of the display which size is obtained in the step (a), in accordance with (i) the size of the display which size is obtained in the step (a), (ii) a size of a reference display which is a predetermined display, and (iii) a width of a reference contour which is a predetermined contour.

14. A method of setting gradation number, comprising the steps of:
(a) obtaining a size of a display; and
(b) setting gradation number, which is the number of gradations of a contour added to a character to be displayed on the display, so that the gradation number is substantially proportional to the size of the display which size is obtained in the step (a).
